(19) United States
(12) Patent Application Publication
(10) Pub. No.: US 2015/0312953 A1
(43) Pub. Date: Oct. 29, 2015

(54) Reliable Multicast/Broadcast for P2P Communications

(71) Applicant: INTERDIGITAL PATENT HOLDING INC., Wilmington, DE (US)

(72) Inventors: Chonggang Wang, Princeton, NJ (US); Qing Li, Princeton Junction, NJ (US); Zongrui Ding, Portland, OR (US); Hongkun Li, Malvern, PA (US); Paul L. Russell, Jr., Pennington, NJ (US)

(73) Assignee: InterDigital Patent Holding Inc., Wilmington, DE (US)

(21) Appl. No.: 14/441,436

(22) PCT Filed: Nov. 7, 2013
(86) PCT No.: PCT/US2013/068883

§ 371 Date: May 7, 2015

Related U.S. Application Data
(60) Provisional application No. 61/723,635, filed on Nov. 7, 2012.

(51) Int. Cl. H04W 76/02; H04L 12/18; H04W 88/02; H04L 1/16

(52) U.S. Cl. CPC H04W 76/023; H04L 1/16; H04L 12/18; H04W 88/02

(57) ABSTRACT

Methods and apparatus may be used to provide reliable multicast or broadcast for peer-to-peer (P2P) communications. A wireless transmit/receive unit (WTRU) may receive a medium access control (MAC) data frame. The MAC data frame may indicate a flexible acknowledgement (ACK) type (e.g., a subset of peers, a single peer, location based, context based, and/or packet type based). The MAC data frame may indicate an ACK sequence. The ACK sequence may indicate an ACK transmission sequence among peers. The WTRU may determine whether to send an ACK message based on the flexible ACK type and/or the ACK sequence. The WTRU may receive an ACK message from a peer. The WTRU may send the ACK message when it is determined that the ACK message should be sent.

### CROSS REFERENCE TO RELATED APPLICATIONS

This application claims the benefit of U.S. Provisional Patent Application No. 61/723,635, filed Nov. 7, 2012, the contents of which are hereby incorporated by reference herein.

### BACKGROUND

In Peer-to-Peer (P2P) communications, group communication may enable various applications and services including gaming and social networking. However, existing P2P communications may not fully support group communications and may not leverage the broadcast nature of a wireless channel. Existing P2P communications may also have low group communication efficiency, such as higher latency and higher overhead, in a wireless P2P environment.

### SUMMARY

Systems, methods, and instrumentalities are disclosed for multicasting or broadcasting associated with peer-to-peer (P2P) communications. A wireless transmit/receive unit (WTRU), e.g., a peer in a peer-to-peer system, may receive a medium access control (MAC) data frame. The MAC data frame may indicate a flexible acknowledgement (ACK) type. For example, a flexible ACK type may include one or more of the following: partial ACK, location-based ACK, context-aware ACK, ACK ordering/sequencing, or the like. The WTRU that receives the MAC data frame may determine whether to send an ACK message based on the flexible ACK type. For example, if a condition is satisfied associated with the flexible ACK type, the WTRU that receives the MAC data frame may determine to send the ACK message. In such a case, the WTRU that receives the MAC data frame may send the ACK message. The ACK message may comprise a positive acknowledgement (e.g., when a MAC data frame is received successfully), a negative acknowledgement (e.g., when a MAC data frame is not successfully received), or a combination of positive and negative acknowledgement.

The flexible ACK type may indicate that the ACK message is to be sent from a subset of peers. The subset of peers may consist of one or more peers. The WTRU may determine to send the ACK message when the WTRU is in the subset of peers.

The flexible ACK type may indicate that the ACK message is to be sent from peers within a proximity to a location. The WTRU may determine to send the ACK message when the WTRU is within the proximity to the location.

The flexible ACK type may indicate that the ACK message is to be sent from peers associated with a context. The context may be associated with link quality, residual energy, application or service profile, application or service category, user profile, device profile, and/or a mobility state (e.g., without mobility or low mobility). The WTRU may determine to send the ACK message when the WTRU is associated with the context.

The flexible ACK type may indicate that the ACK message is to be sent from peers based on a packet type (e.g., packet priority and/or packet quality of information). For example, a high priority packet, such as a packet with a priority above a threshold, may be ACK'd; a low priority packet, such as a packet with a priority below a threshold, may not be ACK'd. The WTRU may determine to send the ACK message when the WTRU receives an indicated packet type.

A peer may be configured to send an ACK message in sequence. A first WTRU (e.g., a first peer) may receive a medium access control (MAC) data frame. The MAC data frame may indicate an ACK sequence, e.g., the MAC data frame may indicate that the first WTRU send an ACK after receiving an indication that a second WTRU (e.g., a second peer) has sent an ACK. For example, the first WTRU may receive an ACK message from the second WTRU. The first WTRU may determine that the first WTRU is next in the ACK transmission sequence based on the received ACK message from the second WTRU. The first WTRU may determine to send an ACK message when determining that it is next in the ACK transmission sequence.

### BRIEF DESCRIPTION OF THE DRAWINGS

A more detailed understanding may be had from the following description, given by way of example in conjunction with the accompanying drawings.

FIG. 1 depicts an example of a centralized one-hop multicast and/or broadcast.

FIG. 2 depicts an example of a hybrid one-hop multicast and/or broadcast.

FIG. 3 depicts an example of a distributed one-hop multicast and/or broadcast.

FIG. 4A depicts an example of a centralized multi-hop multicast and/or broadcast from a virtual leader (VL) to peers.

FIG. 4B depicts an example of a centralized multi-hop multicast and/or broadcast from a peer to other peers via a VL.

FIG. 5 depicts an example of a hybrid multi-hop multicast and/or broadcast from a peer to other peers.

FIG. 6 depicts an example of a tree structure for P2P MAC multicast and/or broadcast.

FIG. 7 depicts an example of functions for a context-aware P2P MAC multicast and/or broadcast.

FIG. 8A depicts an example of broadcast/multicast addressing that may be based on MAC broadcast address and/or group ID.

FIG. 8B depicts another example of broadcast/multicast addressing that may be based on MAC broadcast address and/or group ID.

FIG. 9 depicts an example of a hierarchy MAC unicast address assignment.

FIG. 10 depicts an example of MAC address that may be pre-allocated for multicast.

FIG. 11A depicts an example of a context-aware P2P multicast and/or broadcast admission control.

FIG. 11B depicts another example of a context-aware P2P multicast and/or broadcast admission control.

FIG. 12 depicts a number of example formats for a MAC multicast and/or broadcast data frame.

FIG. 13 depicts an example format for a MAC multicast and/or broadcast ACK frame.

FIG. 14 depicts an example format for an aggregated MAC multicast and/or broadcast ACK.

FIG. 15 depicts a flow chart of an example centralized one-hop multicast and/or broadcast.

FIG. 16 depicts a flow chart of an example hybrid one-hop multicast and/or broadcast.

FIG. 17A depicts a flow chart of an example hybrid one-hop multicast and/or broadcast that may have collaboration.

FIG. 17B depicts another example hybrid one-hop multicast and/or broadcast that may have collaboration.

FIG. 18 depicts a flow chart of an example distributed one-hop multicast and/or broadcast.

FIG. 19 depicts a flow chart of an example distributed one-hop multicast and/or broadcast that may have collaboration.

FIG. 20 depicts a flow chart of an example centralized multi-hop multicast and/or broadcast.

FIG. 21 depicts a flow chart of an example centralized multi-hop multicast and/or broadcast.

FIG. 22 depicts a flow chart of an example hybrid multi-hop multicast and/or broadcast.

FIG. 23A depicts a system diagram of an example communications system in which one or more disclosed embodiments may be implemented.

FIG. 23B depicts a system diagram of an example wireless transmit/receive unit (WTRU) that may be used within the communications system illustrated in FIG. 23A.

FIG. 23C depicts a system diagram of an example radio access network and an example core network that may be used within the communications system illustrated in FIG. 23A.

FIG. 23D depicts a system diagram of an example radio access network and an example core network that may be used within the communications system illustrated in FIG. 23A.

FIG. 23E depicts a system diagram of an example radio access network and an example core network that may be used within the communications system illustrated in FIG. 23A.

### DETAILED DESCRIPTION

A detailed description of illustrative embodiments will now be described with reference to the various figures. Although this description provides a detailed example of possible implementations, it should be noted that the details are intended to be exemplary and in no way limit the scope of the application. In addition, the figures may illustrate one or more message charts, which are meant to be exemplary. Other embodiments may be used. The order of the messages may be varied where appropriate. Messages may be omitted if not needed, and, additional messages may be added.

Disclosed herein are methods and apparatus that may provide reliable multicast or broadcast for peer-to-peer (P2P) communications. Context-aware P2P medium access control (MAC) multicast and/or broadcast architecture may be provided. P2P MAC multicast and/or broadcast addressing may be provided. Context-aware P2P MAC multicast and/or broadcast group management may be provided, which may include one or more of the following: group establishment, group update, receiver selection, or receiver scope control. Context-aware P2P MAC multicast and/or broadcast admission control may be provided. Context-aware P2P MAC multicast and/or broadcast reliability management may be provided, which may include one or more of the following: flexible reliability or acknowledgment (ACK) collision avoidance. Context-aware collaborative P2P MAC multicast and/or broadcast transmission may be provided.

MAC Frames for supporting P2P MAC multicast and/or broadcast may be provided. P2P MAC multicast and/or broadcast may be provided for centralized one-hop multicast and/or broadcast, hybrid one-hop multicast and/or broadcast, distributed one-hop multicast and/or broadcast, centralized multi-hop multicast and/or broadcast, hybrid multi-hop multicast and/or broadcast, or the like.

P2P proximity communications may be provided. P2P proximity communication may be based on the awareness of a peer's proximity for desired services in an infrastructure-based or infrastructure-less configuration. P2P proximity communications may be infrastructure-based or infrastructure-less communications among peers within proximity. P2P proximity communications may be a centralized system or a fully distributed system without a central controller. A peer may be a user (e.g., a device associated with a person and/or entity at a time of use) or a device, e.g., a mobile station (MS) in 2G, a user equipment (UE) in 3GPP, or a full-function device (FFD) or reduced-function device (RFD) in IEEE 802.15 (WPAN). A peer may be a group of users or devices sharing a group ID. Examples of P2P devices include, but are not limited to, connected cars, medical devices, smart meters, smart phones, tablets, laptops, game consoles, set-top boxes, cameras, printers, sensors, and home gateways. Infrastructure-based communications may involve a centralized controller, which may handle one or more of the following: user information, scheduling among users, and/or connection management, such as cellular communications. In infrastructure-less P2P communications, peers may have equal responsibility for initiating, maintaining, and/or terminating a session.

Proximity-based applications and services may use P2P proximity communications. For example, in social networking, peers that may be in proximity may interact with each other at the application level, such as Facebook and Twitter. Two-way communication among two or more peers may be used and traffic data rates may vary. For example, a traffic data rate may be low for some applications, such as for text-based chatting, or a traffic data rate may be high for other applications, such as for content sharing.

Advertising applications may use P2P proximity communications. For example, a store may broadcast its promotions and coupons to the proximity of its location to potential customers, which may be peers. One-way or two-way communication may be used. For example, one-way communication may be used with a low traffic rate. As another example, two-way communication may be used for personalized advertisements.

Emergency applications may use P2P proximity communications. Emergency applications may use P2P proximity communications in a manner similar to that of advertising applications. Emergency applications may use one-way communications, such as an emergency alarm. Emergency applications may use two-way communications, such as emergency safety management. Emergency applications may have a higher priority than other P2P use cases and may have higher privacy requirements.

Gaming applications may use P2P proximity communications. For example, multiple peers may initialize and/or participate in interactive games, such as online multiplayer games. Interactive P2P gaming may use low latency communications.

Smart transportation applications may use P2P proximity communications. For example, cars connected via car-to-car and/or car-to-infrastructure communication may support applications including but not limited to, congestion/accident/event notification; interactive transportation management, which may include carpooling and train scheduling; or smart traffic control. Smart transportation applications may use low data rates, but may use reliable message delivery that may have very low latency.

Network applications may use P2P proximity communications. For example, network applications may be used for coverage extension of infrastructure and/or offloading from the infrastructure. Network applications may use multi-hop.

Some use cases and/or applications described herein may relate to machine-to-machine (M2M) and Internet of things (IoT) communications such as, for example, smart environment applications and smart transportation applications. P2P wireless communications may improve the performance of those M2M/IoT applications. M2M/IoT applications may be enabled by P2P communications.

Infrastructure-based P2P communication may be provided in 3GPP proximity services (ProSe). There may be a number of ProSe/device-to-device (D2D) operation modes. One operation mode may be an operator-free (OF) operation mode. In OF, D2D communication may be standalone and may not have involvement from the operator's network. UEs may make the initial determination of proximity, may target peer discovery, and may make direct connections without support from the network. Peer discovery may be a procedure to enable P2P proximity communications that may be used by a peer to find another peer before peer association. Peer association may be a procedure used by a peer to establish a logic relationship with another peer before P2P data transmission may be started. Peer association may also be referred to as peer attachment, peering, pairing, or link establishment.

Another operation mode may be operator-assisted (OA). In OA, the network/operator may assist UEs with proximity detection and may provide targeted discovery and/or authentication/security. The assistance may be provided proactively by the network or may be provided upon a UE's request. The network may not monitor the reliability of D2D links and may not support session continuity, e.g., if the D2D link is dropped. When a D2D link is dropped, the application layer may provide some level of continuity by re-initiating P2P connections via the network using normal procedures. Another operation mode may be an operator-managed (OM) operation mode. In OM, the network may assist UEs in a manner similar to that of the OA operation mode described herein. The network may also provide radio link monitoring and may provide management, e.g., to support session continuity during D2D communication. If requested, the network may anchor the D2D traffic using, for example, network access resources. The network anchoring may occur when two UEs may be within coverage of the same eNB. The network anchoring may occur across eNBs as session continuity may be requested even as devices may move out of proximity.

Physical (PHY) and MAC layers may be provided for distributed peer-aware communications that may support emerging services which may include but are not limited to: social networking, advertising, gaming, streaming, and emergency services. For example, PHY and MAC may be provided for IEEE 802.15.8. A number of features may be provided for 802.15.8. For example, discovery of peer information without association may be provided for 802.15.8. A discovery-signaling rate of greater than 100 kbps may be provided, and the number of devices in the discovery may be more than 100 devices. Scalable data transmission rates may be provided. The scalable data transmission rates may be 10 MBps. Group communication may be provided that may allow simultaneous membership in multiple groups, such as ten groups. One or more of the following may be provided: relative positioning, multi-hop relay, or security. Infrastructure-less P2P in IEEE 802.15.8 may be operational in selected globally available unlicensed/licensed bands that may be below 11 GHz.

Fast neighbor discovery without association may be provided for IEEE 802.15.8. The neighbor discovery process may be used for peer-to-peer communications and may be used for group communications. The neighbor discovery may be part of functions that may be implemented at PHY and MAC layers. The discovery process may be performed without the association process, which may reduce latency that may be incurred from neighbor discovery.

Fast association with distributed coordination may be provided for IEEE 802.15.8. The association process in IEEE 802.15.8 may not rely on a centralized coordinator or a dedicated server. IEEE 802.15.8 devices may be coordinated in a distributed manner for P2P and/or group communications. If many mobile devices are present, the centralized association process may suffer from overloading. A distributed coordination process may avoid overloading and may achieve faster association.

Group communication may be provided for IEEE 802.15.8. Group communication may support many applications for IEEE 802.15.8 such as, for example, social networking and P2P applications. Those applications may be facilitated by implementing parts of the group communication function at, for example, the PHY and MAC layers. An individual peer aware communications (PAC) device may join multiple groups simultaneously. IEEE 802.15.8 group communication may be managed without a central coordinator.

P2P and/or infrastructure-less communications may be provided for IEEE 802.15.8. IEEE 802.15.8 may support P2P and infrastructure-less communication at the PHY and MAC layers. P2P communication may refer to communication between any two IEEE 802.15.8 devices without a mediating or coordinating device. This mode of communication may be used in networks without infrastructure, such as base stations. P2P communications may be used for multi-hop relay communication, which may support applications for disaster recovery and emergency.

Internet protocol (IP) multicast may be provided. IP multicast may provide multicast services at the IP layer. A multicast IP address may be allocated for a group of interested receivers to join. Receivers may join the group via the multicast IP address, e.g., to formulate the multicast group. Routers may keep a record of the multicast group and its members. When a sender sends an IP packet to the group, it may use its unicast IP address as a source IP address and multicast IP address as a destination address. Routers may be responsible to replicate the IP packet to multiple copies and may forward them to corresponding receivers. There may be many IP multicast protocols such as protocol independent multicast (PIM), which may handle issues such as multicast group management, e.g., group joining or leaving. This may be done, for example, to establish multicast distribution tree and/or multicast packet forwarding. IP multicast may use less IP packet transmissions than an application-level multicast (ALM). IP multicast may introduce increased overhead and may require IP routers to perform one or more of the following: maintain group status, replicate IP packets, and forward IP packets.

ALM may be provided. In ALM, a sender may unicast the same packet sequentially to one or more receivers. ALM may not request support from IP routers and may be transparent to IP routers, which may be in contrast to IP multicast. ALM may generate more traffic and may have a lower transmission efficiency when receivers may be connected to a sender via the same path. ALM may have group management (e.g., group joining or leaving), which may handle end-to-end between the sender and a receiver.

MAC layer multicast may be provided. MAC multicast protocols may be designed for P2P wireless communications and may be used for infrastructure-less P2P communications.

One or more of the following may apply for 802.11 and/or 802.15.

Acknowledgement (ACK) may be defined, but negative ACK (NACK) may not be defined. A MAC data frame may have an acknowledge request (AR) bit that may indicate if acknowledgment is to be used. A MAC data frame header may have a sequence number field, but may not specify whether the sequence number may be incremental, which may mean that NACK may not be interpolated. An ACK frame may have a sequence number.

A group ACK information element (IE) may be defined for an 802 coordinating entity and may be used to acknowledge multiple data frames that may be transmitted in a guaranteed time slot (GTS). Group ACK may allow the server to allocate a time slot for retransmission. An enhanced ACK may be provided and may include additional content as IEs. Multi-channel adaptation and switch may be defined for a sender and receiver pair, e.g., to enable the sender and receiver pair to switch their communication channel.

Incremental ACK (IACK) may be defined, e.g., to assist reliable MAC fragment transmission. An IACK may indicate successfully transmitted fragments and failed fragments. IACK may be a combination of ACK and NACK.

Block ACK may include one or more of the following: immediate block ACK and delayed block ACK.

Group communications may be a feature for P2P communications, which may enable various applications and services, including gaming and social networks. For example, multicast and/or broadcast groups may be established in P2P communications. Existing IP multicast and ALM may support group communication, but may not leverage the broadcast nature of the wireless channel and may lead to low group communication efficiency. For example, existing IP multicast and ALM may have higher latency and higher overhead in a wireless P2P environment.

Multicast and/or broadcast may be implemented at the MAC layer to provide P2P communication, such as infrastructure-less P2P communications. P2P multicast and/or broadcast use cases may request one or more of the following: different quality of services (QoS) levels, flexible reliability of multicast and/or broadcast, or context-aware multicast and/or broadcast reliability.

Some P2P use cases such as, for example, multi-party gaming, may be delay sensitive and may request multicast and/or broadcast mechanisms (e.g., to guarantee low delay or latency). Peers may move in some P2P use cases and may request reliable multicast and/or broadcast under such mobile scenarios. P2P devices may be battery-powered and may request energy-efficient multicast and/or broadcast.

Characteristics and context information in P2P communications may be leveraged to, for example, enable efficient multicast and/or broadcast at the MAC layer for different P2P scenarios. The P2P scenarios may be referred to as P2P MAC Multicast and/or broadcast and may include but are not limited to: one-hop, multi-hop, unicast, multicast, and/or broadcast.

Multicast and/or broadcast mechanisms at the MAC layer are disclosed herein. The multicast and/or broadcast mechanisms at the MAC layer may be used to, for example, enable efficient multicast and/or broadcast. The multicast and/or broadcast mechanisms at the MAC layer may allow peers to be mobile during P2P communication and may allow fast peer association and rapid group membership change. The multicast and/or broadcast mechanisms may be used in a distributed P2P communication system that may not have a central coordinator, and may be used in an infrastructure-less P2P communications system that may not have routers. The multicast and/or broadcast mechanisms may be used in a centralized P2P communication system as well as infrastructure-based P2P communication system.

Architecture and mechanisms for context-aware P2P MAC multicast and/or broadcast may be provided. This may be done to provide, for example, one or more of the following: P2P MAC multicast and/or broadcast addressing, admission control, reliability management, and/or collaborative transmission. Context-Aware P2P MAC multicast and/or broadcast group management may include but is not limited to group establishment, group update, receiver selection and/or scope control. Context-Aware P2P MAC multicast and/or broadcast reliability management may include but is not limited to flexible reliability and/or ACK collision avoidance.

MAC Frames for supporting P2P MAC multicast and/or broadcast may be provided. Procedures for P2P MAC multicast and/or broadcast may be provided, e.g., for one or more of the following: centralized one-hop multicast and/or broadcast, hybrid one-hop multicast and/or broadcast, distributed one-hop multicast and/or broadcast, centralized multi-hop multicast and/or broadcast, or hybrid multi-hop multicast and/or broadcast.

Multicast or broadcast P2P communication may be provided. A medium access control (MAC) data frame may be transmitted (e.g., an entity within a P2P system, such as an transmitting or intermediate peer, a SubVL, or a VL, that is sending data upstream may include a MAC data frame in such transmission). For example, the MAC data frame may be transmitted by multicasting or broadcasting the data frame. The MAC data frame may include an acknowledgment type (e.g., a flexible acknowledgment type) that may instruct a peer (e.g., a peer that is receiving the MAC data frame) to perform an acknowledgment operation. An acknowledgment message generated by a peer using the acknowledgment operation may be received by the virtual leader.

Medium access control (MAC) multicast or broadcast may be provided. MAC data may be transmitted to a peer. The MAC data may include an acknowledgment type, for example, that may instruct the peer to perform an acknowledgment operation. An acknowledge message generated by the peer using the acknowledgment operation may be received. A helper peer to retransmit MAC data may be determined (e.g., to enable collaborative reliable multicast and/or broadcast transmission). A help request message may be transmitted from the source peer to the helper peer, e.g., to request that the helper peer retransmit MAC data. The source peer may request and may receive a list of helper peer candidates from a helper decider (e.g., another peer, VL, SubVL, and/or SuperVL). The helper peer may retransmit MAC data to other peers (e.g., toward the destination peers). The helper peer may generate an aggregated acknowledgement message based on the received acknowledgement messages from other peers. An aggregated acknowledgment message may be received from the helper peer. The helper peer may be a first peer and the aggregated acknowledgment message may include an acknowledgment message from a second peer.

MAC multicast or broadcast may be provided. A peer may be determined. A sub virtual leader (SubVL) to retransmit MAC data may be determined. A SubVL may receive MAC data from a VL. A MAC data frame may be transmitted to a peer via the SubVL. The MAC data frame may include an acknowledgment type, for example, that may instruct the peer to perform an acknowledgment operation. An aggregated acknowledgment message may be received from the SubVL. The aggregated acknowledgement message may include an acknowledgement message that may be generated by the peer using the acknowledgement operation.

Systems, methods, and instrumentalities may be provided for a peer to allow for P2P proximity communications, peer discovery, and peer association. A peer may be a user or a device including but not limited to a mobile station (MS) in 2G, a user equipment (UE) in 3GPP, a full-function device (FFD) and/or a reduced-function device (RFD) in IEEE 802.15/WPAN (wireless personal area network). A peer may be a group of users or a device that may share a group ID. P2P proximity communications may be infrastructure-based or infrastructure-less communications among peers that may be within a proximity. Peer discovery may be used by a peer to find another peer and may be used before peer association to enable P2P proximity communications. Peer association may be used by a peer to establish a logic relationship with another peer and may be used before P2P data transmission may be started. Peer association may be referred to as peer attachment, peering, pairing, or link establishment.

Peers may use association identifiers and/or association content information. An association identifier may be a local identifier that may be used to identify an established association relationship among peers. The association identifier may be assigned during peer association or peer re-association and may be updated during a peer association update. Association context information may be a property and/or information about an association relationship that may be established among peers.

Peers may perform peer association update, peer disassociation, and/or peer re-association. A peer association update may be a procedure that may be used by a peer to update an association identifier and/or an association context that may be associated with an existing association relationship with another peer(s). Peer disassociation may be a procedure used by a peer to cancel an association relationship with another peer(s). Peer re-association may be a procedure that may be used by a peer to re-associate an association relationship with another peer(s).

A peer may be a virtual leader. A virtual leader may be a peer tasked to represent, manage, and/or coordinate P2P communications among a group of peers that may share the same context-based service or application, such as within a P2PNW, for centralized intra-P2PNW control. A virtual leader may be dynamically determined and/or changed within the group (P2PNW). A virtual leader may perform functions for the group (P2PNW) including but not limited to context management, context-aware discovery broadcast, context-aware peer association, group membership management, synchronization, link management, channel allocation and accessing control, reliable data transmission, routing management, power control and interference management, and/or channel measurement coordination. A peer may be a virtual leader for one application (P2PNW), and one application (P2PNW) may have one virtual leader. A virtual leader may be referred to as a group leader, group header, group controller, group coordinator, group master, group manager, cluster leader, cluster header, cluster controller, cluster coordinator, cluster master, cluster manager, zone leader, zone header, zone controller, zone coordinator, zone master, zone manager, or coordinator.

A peer may be a sub-virtual leader (SubVL). A SubVL may be a peer that may be tasked to extend coverage, e.g., through multi-hop based on the physical or logical topology for centralized intra-P2PNW control. A sub-virtual leader may manage a subgroup of peers with the same context-based service or application (P2PNW). A sub-virtual leader may be a peer (e.g., a member) under the management of the virtual leader and/or a sub-virtual leader of the same group (P2PNW). A sub-virtual leader may perform a subset of functions of the virtual leader.

A peer may be a super virtual leader (SuperVL). A SuperVL may be a virtual leader that may be tasked to coordinate virtual leaders of P2PNWs in proximity for centralized inter-P2PNWs control. e.g., for the purposes of synchronization, power control, interference management, channel allocation, and/or accessing control. A super virtual leader may be dynamically determined and/or changed among the virtual leaders in proximity. The super virtual leader may be a top leader of a virtual leader hierarchical structure for centralized inter-P2PNWs control.

P2P MAC multicast and/or broadcast modes or use cases may be provided. For example, Table 1 depicts a number of P2P MAC multicast and/or broadcast use cases or modes:

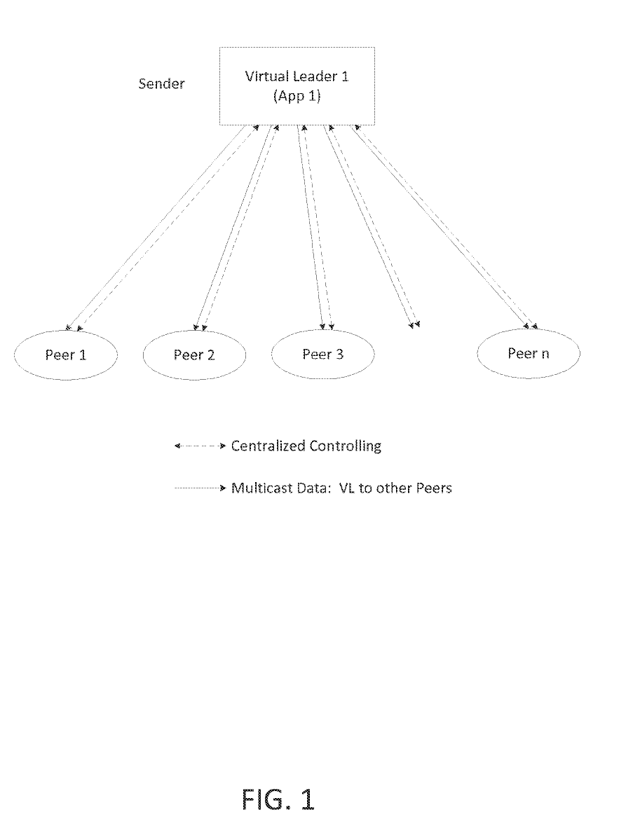

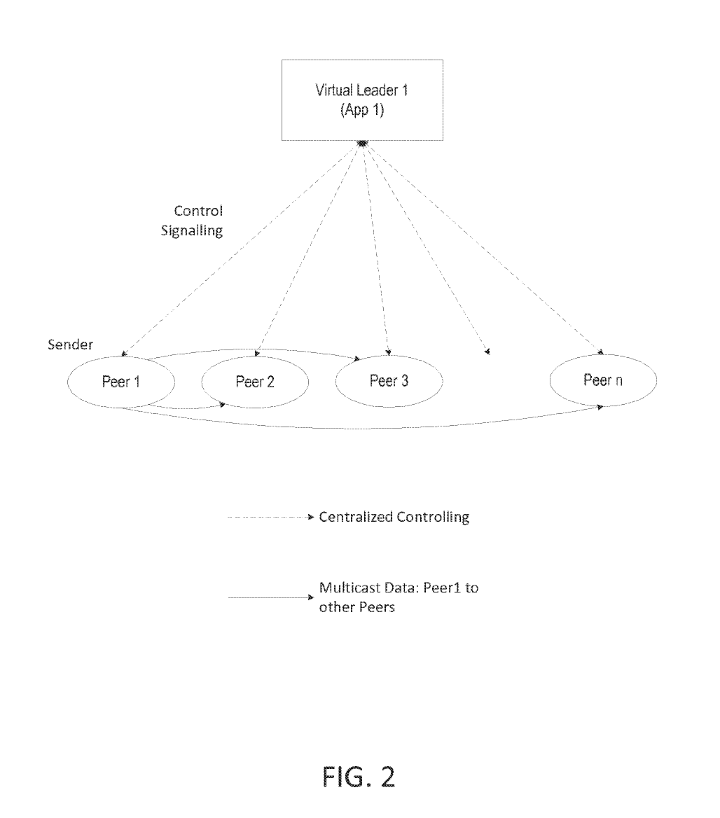

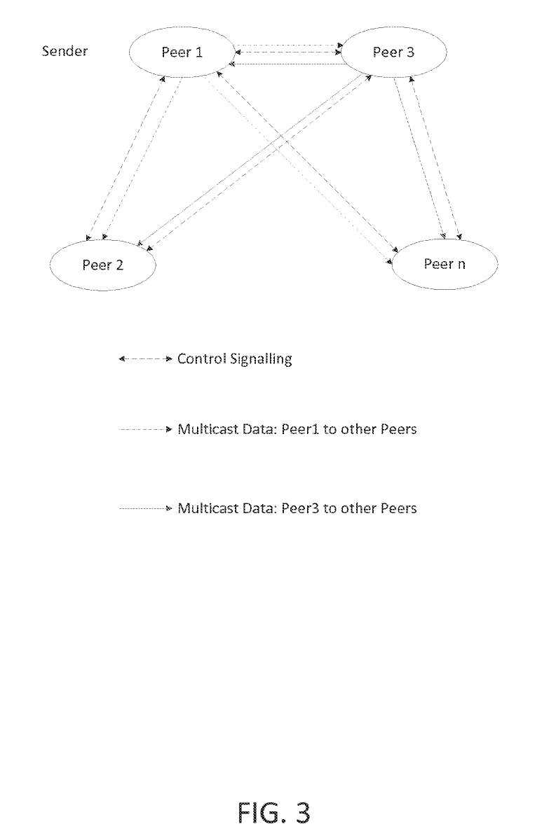

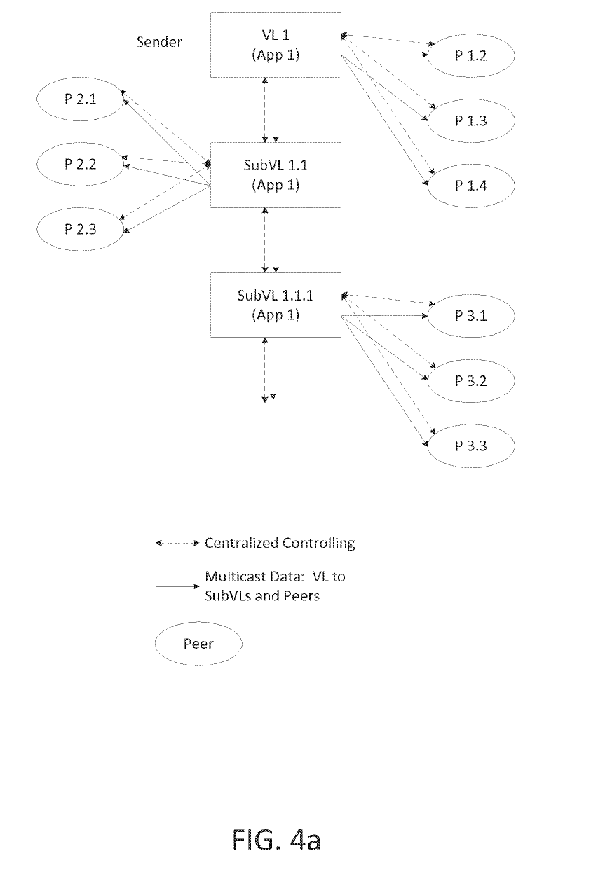

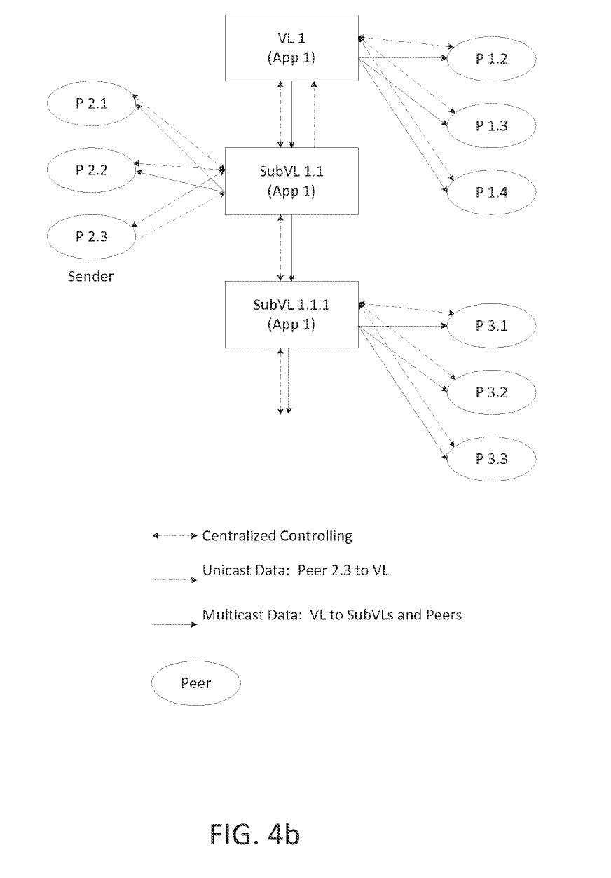

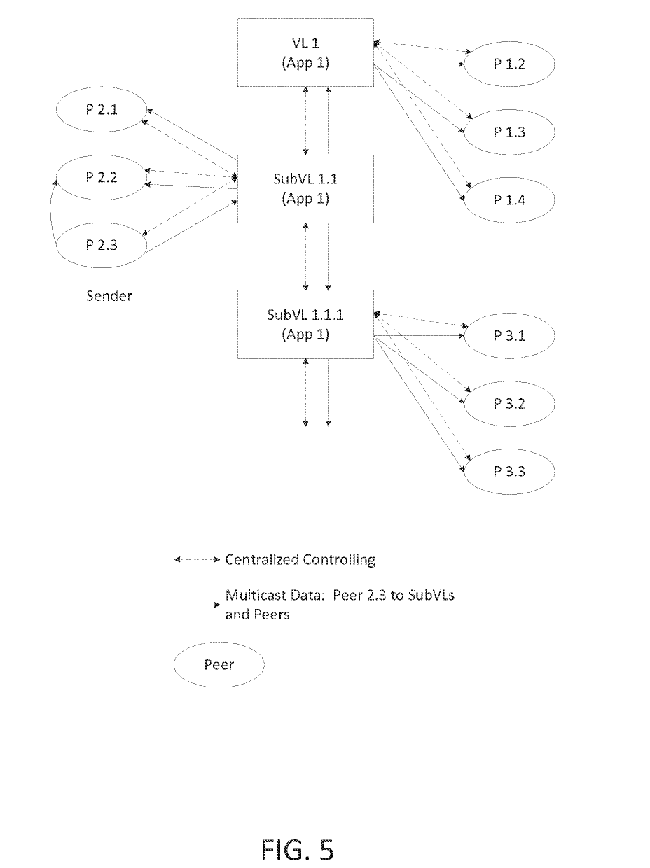

TABLE 1

| | Control | | | | Existence |
|---|---|---|---|---|---|
| Use Case | Plane | Data Plane | Sender | Hop | of VL |
| Centralized One-Hop VL-to- | May be | May be | VL | 1 | Yes |
| Peers Multicast and/or Broadcast | Centralized | Centralized | | | |
| (FIG. 1) | at VL | at VL | | | |
| Hybrid One-Hop Multicast | May be | May be | Peer | 1 | Yes |
| and/or Broadcast | Centralized | Distributed | | | |
| (FIG. 2) | at VL | at Peer | | | |
| Distributed One-Hop Multicast | May be | May be | Peer | 1 | No |
| and/or Broadcast | Distributed | Distributed | | | |
| (FIG. 3) | at Peer | at Peer | | | |
| Centralized Multi-Hop VL-to- | May be | May be | VL | >1 | Yes |
| Peers Multicast and/or Broadcast | Centralized | Centralized | | | |
| (FIG. 4A) | at VL | at VL | | | |
| Centralized Multi-Hop Peer-to- | May be | May be | Peer | >1 | Yes |
| Peers Multicast and/or Broadcast | Centralized | Centralized | | | |
| (FIG. 4B)) | at VL | at VL | | | |
| Hybrid Multi-Hop Multicast | May be | May be | Peer | >1 | Yes |
| and/or Broadcast | Centralized | Distributed | | | |
| (FIG. 5) | at VL | at Peer | | | |

One-hop P2P multicast and/or broadcast may include one or more of the following. FIG. 1 depicts an example of a centralized one-hop multicast and/or broadcast. As shown in FIG. 1, a virtual leader (VL), such as virtual leader 1, may control transmissions (e.g., among peers 1-n). Virtual leader 1 may multicast and/or broadcast to peers 1-n. FIG. 2 depicts an example of a hybrid one-hop multicast and/or broadcast. As shown in FIG. 2, a VL, such as virtual leader 1, may be the peer responsible for centralized control signalizing. Virtual leader 1 may be able to directly multicast and/or broadcast data to other peers. Virtual leader 1 may indirectly multicast and/or broadcast by controlling peer 1 to multicast and/or broadcast. FIG. 3 depicts an example of a distributed one-hop multicast and/or broadcast. As shown in FIG. 3, there may not be a VL; peers may manage themselves. A peer may also be able to directly multicast data to other peers.

Multi-hop P2P multicast and/or broadcast may include one or more of the following. FIG. 4A depicts an example of a centralized multi-hop multicast and/or broadcast for a virtual leader (VL) to peers. FIG. 4B depicts an example of a centralized multi-hop multicast and/or broadcast for peers-to-peers. As shown in FIG. 4A and FIG. 4B, both control and data transmission may be centralized and may be controlled by the VL, such as VL 1, but may be relayed by SubVLs. Data transmission may be done in an up-and-down manner; the source peer may send data up to the VL and the VL may forward the data down to other peers via one or more SubVLs (e.g., hops).

FIG. 5 depicts an example of a hybrid multi-hop multicast and/or broadcast. As shown in FIG. 5, the VL, such as VL 1, may be responsible for centralized control, but the data may be sent from the source peer to other peers without going to the VL (e.g., data may be sent from a peer to a SubVL, which may multicast and/or broadcast to other peers; data may be sent from a peer to a first SubVL, which may send the data to a second SubVL that may multicast and/or broadcast to other peers, etc.).

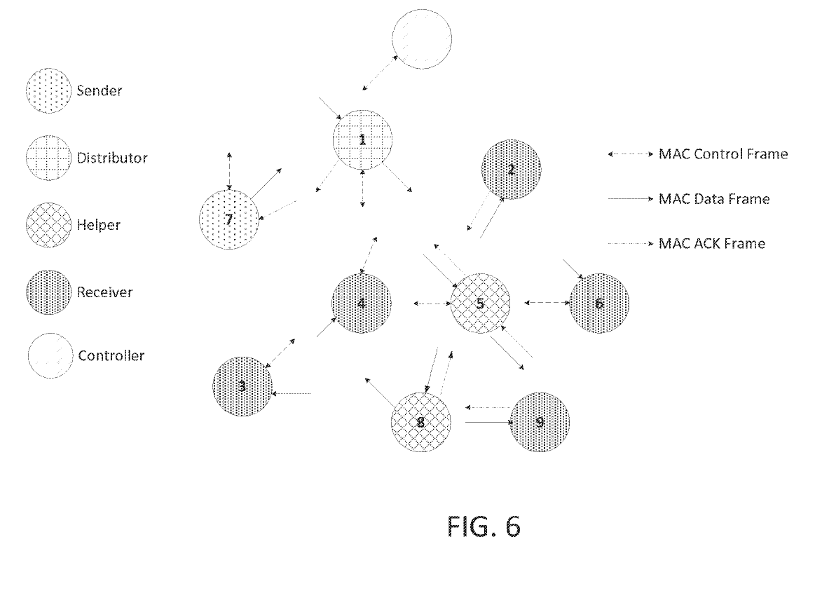

Context-aware P2P MAC multicast and/or broadcast architecture may be provided. FIG. 6 depicts an example tree structure for P2P MAC multicast and/or broadcast. For example, FIG. 6 illustrates a P2P MAC multicast and/or broadcast structure where the multicast distribution tree may include a number of logical entities such as a controller, a sender, a distributor, a helper, and receiver. A controller may not appear in the distribution tree but may be available to establish the multicast distribution tree. A controller may be a distributor. A controller may be a VL or SubVL. A Sender may be the multicast source peer who may multicast and/or broadcast MAC frames to one or more corresponding receivers. The sender may be a VL, a SubVL or a peer.

A distributor may be a peer that may facilitate MAC multicast and/or broadcast as a relay point to forward MAC frames to a group or subgroup of corresponding receivers. The distributor may be a VL or SubVL. The distributor may have the ability and may be willing to multicast and/or broadcast MAC data frames. The distributor may or may not appear in the multicast distribution tree. When a distributor appears in the multicast distribution tree, the multicast and/or broadcast sender may transmit MAC frames to the distributor, and, the distributor may forward (e.g., multicast and/or broadcast) the MAC frames to receiver(s). When a distributor does not appear in the multicast distribution tree, the sender may be regarded as a distributor and may multicast and/or broadcast MAC frames to the receiver(s). The sender may try to find a distributor using peer discovery and association. The sender may stop a multicast and/or broadcast attempt if no distributor is found.

A helper may be an intermediate peer in the multicast distribution tree. A helper may be a distributor or receiver. VL, SubVL, or peers may be requested or assigned as helpers. A helper may forward the received MAC data frame to the next hop. The helper may enable collaborative P2P MAC multicast and/or broadcast. The helper may perform MAC frame retransmission in a hop-by-hop manner. The helper may perform MAC ACK frame aggregation.

A receiver may be a corresponding end peer that may receive MAC frames. A leaf node in a multicast distribution tree may be a receiver. An intermediate node in the multicast distribution tree may be a receiver and/or a helper.

A multicast distribution tree may be established using one or more of the following. A multicast distribution tree may be established via association procedures. A multicast distribution tree may be established using a separate tree approach. In a separate tree approach, independent and dedicated multicast distribution trees may be established for each sender. When another peer wants to be the sender and may multicast and/or broadcast a MAC frame, a multicast distribution tree may be created. A multicast distribution tree may be established using a joint tree approach. In a joint tree approach, a single joint multicast distribution tree may be created for potential senders if they use the same distributor and have the same set of receivers. A receiver on the joint tree may become a sender, and/or may multicast and/or broadcast a MAC frame on the same multicast distribution tree.

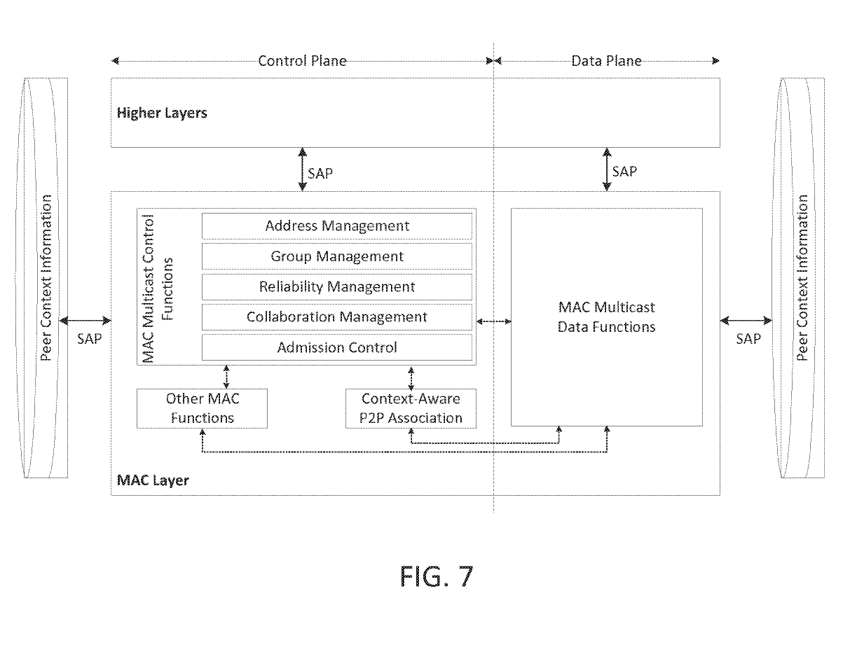

FIG. 7 depicts an example of functions for a context-aware P2P MAC multicast and/or broadcast. For example, FIG. 7 may depict context-aware P2P MAC multicast and/or broadcast functions at one or more peer(s). Some functions may depend on the role of the peer (e.g., controller, sender, distributor, helper, or receiver). MAC multicast control functions (MMCF) may be provided. MAC multicast data functions (MMDF) may be provided.

An MMCF may control and manage MAC multicast and/or broadcast. An MMCF may have capabilities including but not limited to MMDF and/or other MAC functions including context-aware peer association. MMCF capabilities may be accessed and/or invoked by higher layers. An MMCF may access peer context information. MMCF capabilities may include one or more of the following: adjustment management, group management, reliability management, collaboration management, or admission control. MMCF capabilities may interact with each other. Address management may be used to manage MAC addresses, e.g., to implement multicast and/or broadcast in a MAC layer. Group management may be used to manage a multicast and/or broadcast group. Group management may include but is not limited to group joining and leaving, and/or multicast and/or broadcast receiver control. Reliability management may be used to manage multicast and/or broadcast reliability and may provide flexible reliability of multicast and/or broadcast. Collaboration management may be used to manage and control whether or how collaborative multicast and/or broadcast may be enabled. This may be done, for example, to improve MAC multicast and/or broadcast performance, such as efficiency and reliability, via mechanisms such as collaborative retransmission and ACK aggregation. Admission control may be used to manage and control a multicast and/or broadcast request (e.g., authentication and approval) from a sender.

MMDF may be responsible to transmit, forward, and/or retransmit MAC frames. An MMDF may interface with and/or be invoked by higher layers, MMCF, and/or other MAC functions. As disclosed herein, MAC frames may be generated for incoming packets or messages from higher layers where higher layer supports IP multicast or the ALM.

P2P MAC multicast and/or broadcast addressing may be provided. MAC addressing may support multicast and/or broadcast at the MAC layer. Systems, methods, and instrumentalities are disclosed herein to address a group of peers, such as receivers, at the MAC layer.

MAC broadcast address and Group ID may be used (e.g., to address a group of receivers). The Group ID may be an application ID, VL ID, a location-dependent ID, a local ID, or combination thereof. The Group ID or MAC broadcast address may be assigned during a peer association procedure. These IDs may be hashed and then combined with a MAC broadcast address. A MAC multicast and/or broadcast MAC data frame may comprise a MAC broadcast address, which may be the MAC destination address, and a group ID, which may be a filter adapted to indicate if a peer is to receive/accept the incoming data frame or not.

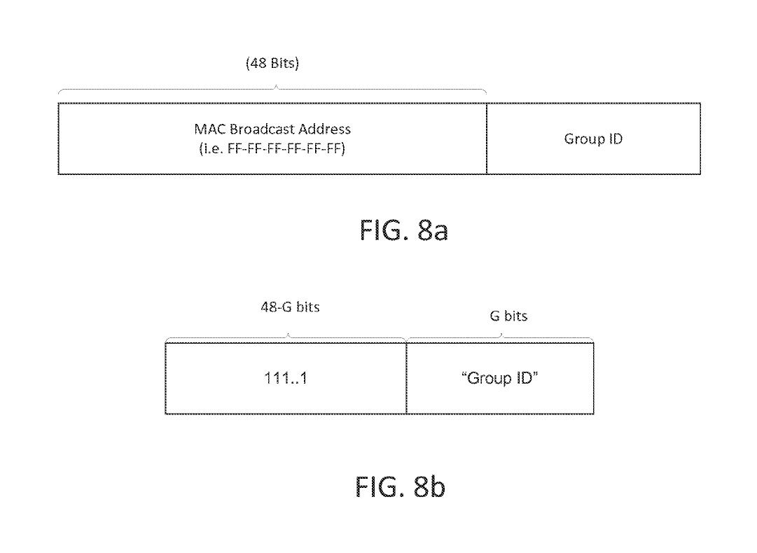

Combining MAC broadcast address and Group ID may be disclosed. FIG. 8A depicts an example of broadcast/multicast addressing that may be based on MAC broadcast address and/or group ID. As shown in FIG. 8A, MAC broadcast address and Group ID may be combined by concatenating MAC broadcast address and Group ID. A MAC multicast and/or broadcast MAC data frame may include MAC broadcast address, which may be the MAC destination address, and Group ID, which may be a filter by the receiver or receiving peer adapted to indicate if a peer is to receive/accept the incoming data frame or not.

FIG. 8B depicts an example of broadcast/multicast addressing that may be based on MAC broadcast address and/or group ID. As shown in FIG. 8B, MAC broadcast address and Group ID may be combined by setting Group ID such that Group ID may have less bits than MAC broadcast address. For example, Group ID may have G bits (e.g. <48 bits) and MAC broadcast address and Group ID may be integrated together such that the total length may be 48 bits. The last G bits may be equal to Group ID and the rest of the bits (e.g., 48−G) may be equal to 1.

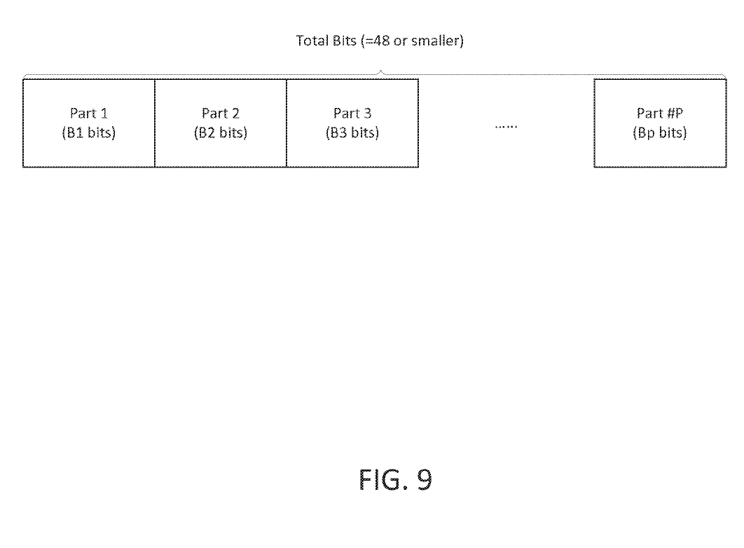

Unicast address and Group ID may be used to address a group of receivers. FIG. 9 depicts an example of a hierarchical MAC unicast address assignment. A unicast address may correspond to a receiver or a helper. A MAC multicast and/or broadcast MAC data frame may include a set of MAC unicast addresses and the group ID. The MAC unicast address for a peer may be a short address or a hashed value of an original MAC unicast address. The MAC unicast address, if unequal to the original MAC unicast address, may be assigned during context-aware peer association. A hierarchical MAC unicast address may be assigned to peers. e.g., when a MAC unicast address (e.g., new MAC unicast address) is assigned during a context-aware peer association procedure. The hierarchical MAC unicast address may reflect the virtual topologies among peers. The hierarchical MAC unicast address may be leveraged for multi-hop frame forwarding. This may be implemented, for example, by dividing the unicast address into multiple P parts (e.g., P=12) such that each part. P, has Bi bits (e.g., Bi=4). A part may be used to represent a respective (e.g., different) topology level. For example, a first part may be used for the highest or the first level and a second part may be used for the second level, etc. A part may have the same or different number of bits as other parts. For example, in FIG. 4. VL 1 may be assigned “1” (e.g., “0001”) as its MAC unicast address, “1.1” (e.g., 00010001) for SubVL 1.1, and “1.1.1” (e.g., “000100010001”) for SubVL 1.1.1, when Bi may be equal to 4.

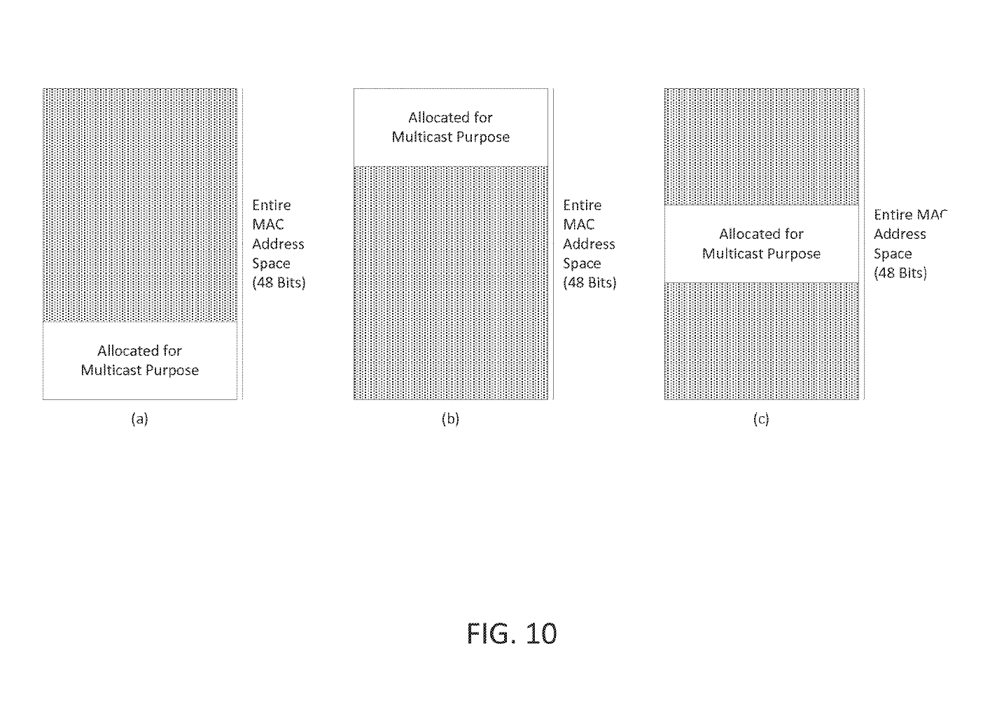

MAC addresses may be pre-allocated, for example, to address a group of peers. FIG. 10 depicts an example of MAC addresses that may be pre-allocated for multicast. The pre-allocated MAC addresses may be used for MAC multicast purposes. As shown in FIG. 10, the pool of allocated MAC addresses for multicast purpose may be at the beginning of, at the end of, or in the middle of the MAC address space. For example, MAC addresses may be specified if their prefix is equal to a specific value or is in a specific range that is used for MAC multicast. A MAC multicast address may be chosen or decided from the pool of MAC multicast addresses, e.g., during multicast group establishment, such as peer association procedures. A multicast MAC data frame may include a multicast MAC address as the destination address.

Systems, methods, and instrumentalities may be disclosed to avoid conflict that may occur when more than one group in the proximity may use the same MAC multicast address. When a group is established, it may announce its MAC multicast address within the proximity so that other groups in the proximity may not choose the same MAC multicast address. The MAC multicast address may be determined based on one or more of the following: the application ID, VL ID or location of the VL. The selected MAC multicast address may equal a hash, e.g., a hash of one or more of the following: application ID, VL ID, or the location of the VL. The hash may be a many-to-one or one-to-one function.

Context-aware P2P MAC multicast and/or broadcast group management may be provided. Context aware P2P MAC multicast and/or broadcast group management may include but is not limited to group establishment, group update, and/or receiver management. Group establishment may occur before a sender may transmit MAC frames. A multicast and/or broadcast distribution tree may be formulated. The multicast and/or broadcast distribution tree may be formulated after group establishment. Context-aware peer association may be leveraged for group establishment. Group update may allow peers (e.g., new peers) to join an established group (e.g., at any time). Group update procedures may allow existing peers to leave an established group (e.g., at any time). Context-aware peer association procedures may be leveraged for group update.

Receiver management may be used, e.g., to adjust receiver scope. Receiver management may include but are not limited to one or more of the following: peer selection, peer list request, peer list response, or receiver scope control. Peer selection may be provided. If the application does not specify the group members by some group information or requests (e.g., requesting peers at a physical location, requesting peers with the same and/or similar device profile), the VL may pick the peers to receive the multicast and/or broadcast information based on different context information, including but not limited to transmission statistics from a last round and/or peer context information. The sender or a helper may check with the controller (e.g., the VL and/or SubVL) to get a list of peers for receiving MAC data frames and/or retransmission. The sender may send a peer list request to the controller (e.g., the VL and/or SubVL), e.g., to get a list of peer(s) for receiving MAC data frames and/or retransmission. The controller (e.g., the VL and/or SubVL) may perform peer selection based on context information, such as peer context information, and may send back a peer list response to the sender and/or the helper. A peer selection process may be performed before the multicast and/or broadcast session starts. Peer selection may be performed periodically during the multicast and/or broadcast session. The sender or the helper may perform peer selection, for example based on its locally maintained context information without sending a request to the controller (e.g., the VL and/or SubVL).

A peer list request may be a message. A peer list request may include, but is not limited to, one or more of the following: multicast type such as geographical multicast and/or broadcast or group based multicast and/or broadcast. The peer list request may include but is not limited to one or more of the following: application/service type and requests regarding multicast reliability, such as packet-level reliability, event-level reliability, and/or location-based reliability. The peer list request may include a list of peers who may have successfully received the data from a previous multicast round. The peer list request may include a retransmission indication, which may be used to indicate if the next multicast round may be for a new transmission or a retransmission. If the retransmission indication is not included in the peer list request message, it may be contained in a peer list response message. A peer list response message may include a list of peers for a next multicast round.

Receiver management may include receiver scope control. A sender, controller, or distributor may request how far in the network a MAC frame may be multicast and/or broadcast. Receiver scope control may be decided with context-awareness. For example, the application message included in the MAC frame may have an age. If the age is expired, the application message may not be forwarded to the next hop. As another example, the physical distance and/or the number of hops for multicasting/broadcasting a MAC frame may be specified, which may limit the multicast and/or broadcast scope.

Receiver scope control may be performed and/or controlled using MAC data frame fields/parameters, such as expiration, multicast and/or broadcast scope, and/or maximum retries. Expiration may be the expiration time of the included message. Multicast and/or broadcast scope may be the physical distance or the number of hops to multicast and/or broadcast the MAC frame. Maximum retries may be the maximum retransmissions of the MAC frame.

Context-aware P2P MAC multicast and/or broadcast reliability management may be provided. MAC multicast and/or broadcast in P2P environments may not request each receiver to perform retransmission-based reliability for each multicast and/or broadcast MAC frame. Context-aware flexible reliability and ACK collision avoidance are described herein.

Context-aware flexible multicast and/or broadcast reliability may be provided. A sender may indicate ACK type (e.g., flexible ACK type) in a MAC data frame, or may indicate ACK type during group establishment, such as during context-aware peer association. Based on the ACK type, a receiver may determine whether to perform a corresponding acknowledge. When the receiver determines to perform the corresponding acknowledge, the receiver sends an ACK (e.g., an ACK message).

An ACK type may indicate the type of requested acknowledgement and/or relevant information. An ACK type such as full ACK or flexible ACK (e.g., partial ACK, location-based ACK, context-aware ACK, ACK ordering/sequencing, etc., may be examples of flexible ACK types) may support flexible multicast and/or broadcast reliability. The distributor and helpers may change/update ACK type based on their local context information before forwarding the MAC data frame to the next hop.

There may be a number of ACK types. An ACK type may be a type 1 or full ACK, which may be where each member/peer may ACK, for example, send ACK messaging, (e.g., send an ACK). This may be referred to as 100% ACK. Less than full ACK may be referred to as flexible ACK. An ACK type may be a type 2 or partial ACK, which may be where a portion of peers (e.g., a subset of peers) may ACK (e.g., designated to send ACK messaging). This may be referred to as partial ACK. Additional information may be included in this field (e.g., ACK type field) such as the percentage of peers to send ACK messaging, the members of the subset designated to ACK, etc. An ACK type may be a type 3 or one ACK (e.g., any ACK), which may be where an ACK may be requested to be sent from one member/peer. If a member/peer sends back an ACK successfully, other members/peers may not need to ACK (e.g., a peer that detects or is notified of the successful ACK may not send ACK messaging). An ACK type may be a type 4 or location-based ACK, which may be where one or more peers around a location (e.g., within a proximity to a location) may be requested to ACK. This may be referred to as location-based ACK. Additional location information may be included in this field. An ACK type may be a type 5 or context-based ACK, which may be where peers associated with a context (e.g., without mobility or low mobility) may be requested to send back ACK. This may be referred to as context-aware ACK. As disclosed herein, other context information may be leveraged to decide if an ACK may or may not be requested. An ACK type may be a type 6 or information-based ACK, which may be used to indicate if ACK is requested for each packet, a subset of packets, on a condition that information (e.g., a command or an event) is decoded, etc. For example, ACK may be issued based on each packet type (e.g., a high priority packet, such as a packet with a priority above a threshold, may be ACK'd and a low priority packet, such as a packet with a priority below a threshold, may not be ACK'd). The receiver may not acknowledge each packet, but may send acknowledgement when the intended information (e.g. a command or an event) may be successfully decoded and/or inferred from multiple received packets.

Content-aware ACK collision avoidance may be provided. Multiple members/peers may act as receivers and may send back ACK after they receive a multicast MAC data frame from the sender, distributor, or helper; those ACKs may be potentially in alignment with each other and may result in collisions. Systems, methods, and instrumentalities may be provided to avoid and/or mitigate potential ACK collisions.

An ACK broadcast may be used to avoid and/or mitigate potential ACK collision. If the ACK type is a type 3, which may be where an ACK may be from one (e.g., any) member/peer, a member/peer may broadcast its ACK so that other members/peers in the proximity may hear this ACK and may avoid sending a redundant ACK. This may mitigate ACK explosion or collision by, for example, reducing the potential for concurrent ACK transmissions from multiple members/peers within the proximity. Even if the ACK may be unicast, other members/peers within the proximity may be able to overhear the ACK and may avoid redundant ACK transmission. If the ACK type is type 2, where a portion of peers may send back ACK, a member/peer may broadcast its ACK such that other members/peers in the proximity may hear the ACK and may avoid sending a redundant ACK. This may occur, for example, by enabling the other member/peers to overhear the number of transmitted ACKs such that they may be able to determine that the requested ACK percentage may or may not be satisfied. When the requested ACK percentage may be satisfied, the other member/peers may not send (e.g., broadcast) ACK. When the requested ACK percentage is not satisfied, the other member/peers may send (e.g., broadcast) ACK.

ACK alignment may be used to avoid and/or mitigate potential ACK collision. When the sender, distributor, or helper multicasts/broadcasts a MAC data frame, it may specify how its neighbors, which may be receiving members/peers, may transmit ACK back. Fields or parameters may be included in a MAC data frame, such as ACK order, ACK transmission behavior, or the like. An ACK order (e.g., sequence) may be included in a MAC data frame. The ACK order may describe the order (e.g., sequence) that neighbors (e.g., receiving peers) may use to send ACKs. For example, an ACK order may indicate what neighbor may send back ACK first and which neighbor may send back ACK last. If neighbors know each other's unicast address, device ID, or user ID, the ACK order may be based on the value of their unicast address, device ID, and/or user ID. For example, the member/peer with the maximum value of unicast address (or device ID, or user ID) may transmit ACK first, while the member/peer with the minimum value of unicast address may send ACK last. ACK transmission behavior may specify how ACK may be sent back from a receiving member/peer. For example, ACK may be sent back using unicast or broadcast. ACK may be sent using content-based channel access or content-free channel access. ACK transmission behavior may determine how long a back-off time may be requested if content-based channel access may be used. The parameters/behaviors that may be indicated in an ACK transmission behavior may be different for different receiving members/peers. For example, a receiving member/peer, such as a SubVL, with more next-hop neighbors may be given a higher priority to send back ACK. This may be done, for example, by giving the receiving member/peer a shorter back-off time or a guaranteed time slot.

ACK Aggregation may be used to avoid and/or mitigate potential ACK collision. An intermediary peer (e.g., distributor or helper) may aggregate ACKs from downstream neighbors and may forward them to an upper level. The intermediary peer may send an aggregated ACK to the upper level, e.g., independently, in response to a request from the upper layer, etc. Sending an aggregated ACK to the upper level may reduce the number of ACK transmissions (e.g., to the upper level). Formats for aggregated MAC multicast and/or broadcast ACK are described herein. FIG. 14 depicts an example format for an aggregated MAC multicast and/or broadcast ACK. An aggregate ACK may include one or more of the following fields: hash (e.g., group ID, application ID, or VL ID), multicast source address, success/failure flag, or list of successful/failed receivers.

Context-aware collaborative P2P MAC multicast and/or broadcast transmission may be provided. Collaborative retransmission may be used to provide context-aware collaborative P2P MAC multicast and/or broadcast transmission. Intermediate peers (e.g., VL and SubVL) or end peers may be selected as helpers to retransmit MAC frames. This may be done, for example, to expedite retransmission, to improve multicast and/or broadcast reliability, and/or to improve efficiency. A helper may be determined by a controller, a distributor, a sender, other helpers, or a receiver. The helper, the distributor, or the controller may perform MAC ACK aggregation. In order to facilitate helper selection, information/parameters may be included in the MAC multicast and/or broadcast ACK frame.

The information/parameters may include but is not limited to helper willingness, a list of buffered data, traffic load, and/or a list of neighbors. Helper willingness may be used to indicate if the sender of this ACK may or may not be willing to act as a helper. A list of buffered data may be a list of sequence numbers of buffered data at the sender of this ACK frame. Traffic load may be a traffic load of the sender of this ACK. A list of neighbors may be neighbor information of the sender of this ACK, which may include but is not limited to link quality to a neighbor and/or traffic load at a neighbor.

Messages and/or procedures used during multicast and/or broadcast sessions may be provided to select helpers (e.g., appropriate helpers), for example, during a collaborative retransmission procedure. A helper list request message may be provided. A helper requestor (e.g., the sender or an existing helper) may send a helper list request message to a helper decider (e.g., the controller, the distributor, or an existing helper). The helper decider may perform helper selection to select one or more helpers for the helper requester. The helper decider may maintain information for one or more peers in the network, which may include but is not limited to one or more of the following: the link quality between two peers, the location of a peer, the traffic load of a peer, or the time length a peer may be a helper.

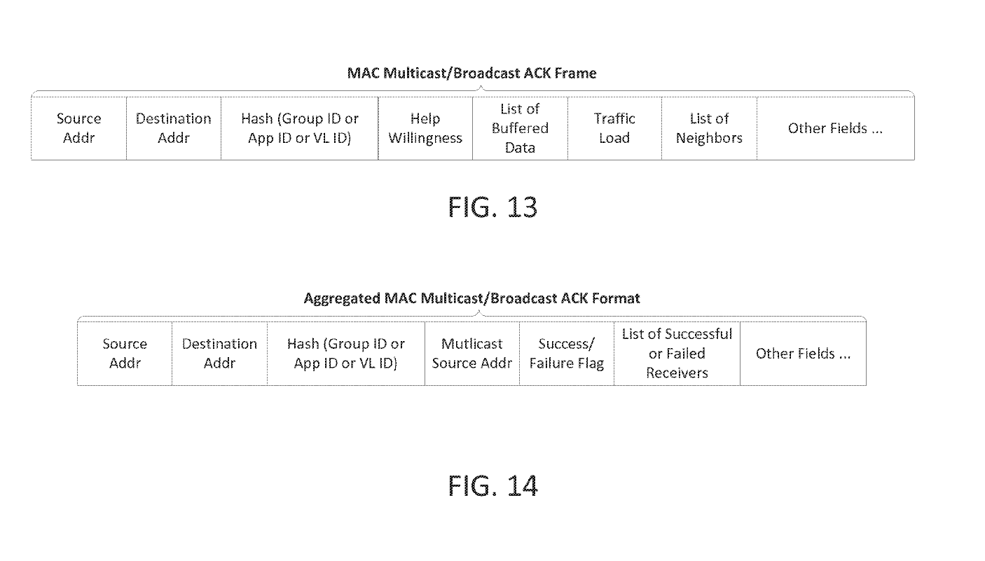

A helper list request message may include information which may include but is not limited to one or more of the following: helper candidates, location of helper candidates, number of requested helpers, help candidate history, or a location of the helper requester. Helper candidates may be a list of peers that have successfully received a previous data frame. Those peers may be regarded as helper candidates. The helper requestor may select helper candidates (e.g., better helper candidates) based on the parameters that may be included in the ACK frame, which may include but is not limited to helper willingness and/or traffic load. Examples of parameters that may be included in the ACK frame may include one or more of the parameters in FIG. 13 (e.g., hash, help willingness, list of buffered data, traffic load, or list of neighbors). The location of a helper candidate may include a location of one or more helper candidates. The number of requested helpers may be the number of helpers requested by the helper requester. The helper decider may decide how many helpers may be selected for the helper requestor. e.g., when the number of requested helpers parameter is not used. Help candidate history may be statistic history information of one or more helper candidates and may include information such as how successfully it receives data from the sender and how successfully it helps other peers. A location of the helper requester parameter may include the location of the helper requestor.

A helper list response message may be provided. The helper list response message may be used by a helper decider to notify a help requester of selected helpers. The helper list response message may include one or more of the following: a list of selected helpers or time duration for one or more selected helpers. Time duration for the one or more selected helpers may indicate how long a selected helper may help the helper requester, and/or may indicate how many data frames that a selected helper may help retransmit. The helper decider may determine the time duration for one or more selected helpers, and may send a message to one or more selected helpers to notify the one or more selected helpers of the time duration.

A help request message may be provided. A helper requester may send a help request message to a selected helper. The source peer (e.g., helper requester) may indicate which buffered data packet may be retransmitted by the helper. A help response message may be provided. The help response message may allow a helper to send a YES or NO indication to the helper requester, e.g., to notify the helper requester if the helper may be able to provide help.

MAC ACK aggregation may be used to provide content-aware collaborative P2P MAC multicast and/or broadcast transmission. A distributor or a helper may aggregate MAC ACKs from other helpers or receivers, may generate an aggregated MAC ACK frame, and may forward the aggregated MAC ACK to the sender or an upstream helper or the distributor. Formats for aggregated MAC multicast and/or broadcast ACK are described herein. FIG. 14 depicts an example format for an aggregated MAC multicast and/or broadcast ACK, which may include one or more of the following: hash (e.g., group ID, application ID, or VL ID), multicast source address, success/failure flag, or list of successful/failed receivers.

Context-aware P2P MAC multicast and/or broadcast admission control may be provided. When there is a distributor or controller in the multicast distribution tree, context-aware P2P MAC multicast and/or broadcast admission control may be used to arbitrate. A sender may send a multicast and/or broadcast request to a controller and/or a distributor (e.g., the VL). The multicast and/or broadcast request may comprise information/parameters which may include one or more of the following: a list of receivers, a multicast type, an application/service type, or multicast reliability requests. A list of receivers may be a list of one or more receivers that may receive MAC frames. A multicast type may be a geographical multicast and/or broadcast, a group based multicast and/or broadcast, or the like. Application/service type and multicast reliability requests may be based on packet-level reliability, event-level reliability, location-based reliability, or the like. A VL may send back a multicast and/or broadcast response to a peer. The multicast and/or broadcast response may include information such as the list of approved member peers and/or reliability requests.

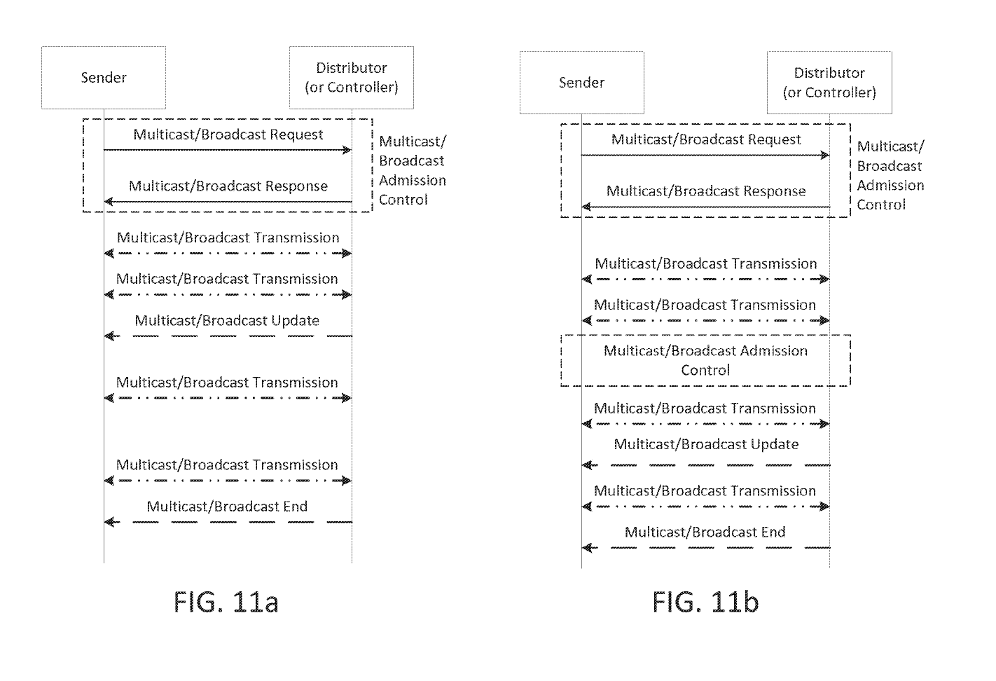

A distributor or a controller may adjust or stop an existing multicast and/or broadcast session. This may be seen in FIG. 11A and FIG. 11B. The distributor or the controller may wish to adjust an aspect of an existing multicast and/or broadcast session, such as the sending rate of MAC frames at the sender, by sending a multicast and/or broadcast update message to the sender. The multicast and/or broadcast update message may include sending rate information, which may be a sending rate of MAC frames at the sender. The distributor or controller may wish to stop the existing multicast and/or broadcast session by issuing a multicast and/or broadcast end message to a sender. The multicast and/or broadcast end message may include an end reason, which may be a reason for ending the current multicast and/or broadcast session such as overloaded traffic at the distributor or the controller. A multicast and/or broadcast request may be piggybacked in a MAC multicast and/or broadcast data frame.

FIG. 11A depicts an example of a context-aware P2P multicast and/or broadcast admission control. This may be done, for example, to arbitrate whether subsequent multicast and/or broadcast transmissions are allowed. For example, the multicast and/or broadcast session may be allowed. Admission control may occur before the first multicast and/or broadcast transmission. This may be referred to as one-time admission control.

FIG. 11B depicts an example of context-aware P2P multicast and/or broadcast admission control. This may be done, for example, to arbitrate if a next multicast and/or broadcast transmission may be allowed. Admission control may occur before starting the next multicast and/or broadcast transmission, or may occur periodically after a number of multicast and/or broadcast transmissions. This may be referred to as periodic admission control.

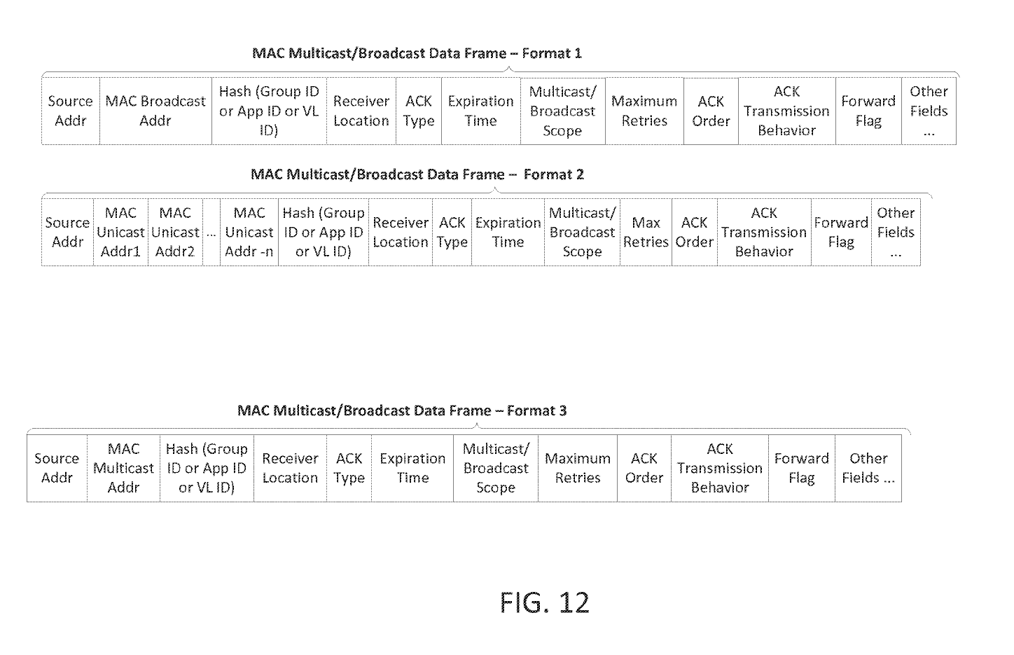

A MAC frame format may be provided. A MAC multicast and/or broadcast data frame may be provided. FIG. 12 depicts example formats for a MAC multicast and/or broadcast data frame. As shown in FIG. 12, Format 1 may be a format where a destination MAC address may be the broadcast address. Format 2 may be a format where a destination MAC address may be the list of MAC addresses of receivers/destinations of this frame, which may be dynamic for a retransmitted multicast and/or broadcast data frame. Format 3 may be a format where a destination MAC address may be a MAC multicast address, such as a MAC multicast address described herein.

A MAC multicast and/or broadcast data frame, such as Format 1, Format 2, or Format 3, may include a number of fields or parameters that may include one or more of the following: a hash, a receiver location, an ACK type, an expiration time, a multicast and/or broadcast scope, a maximum retries, an ACK order, an ACK transmission behavior, or a forward flag. A hash may be a hashed value, which may include one or more of the following: a group ID, an application ID, a VL ID, or a peer location. The receiver location may be a location of members/peers that may receive a data frame. If peer location is included in a hash, the receiver location may or may not be provided. ACK type may indicate a type of requested acknowledgement and relevant information. ACK type may support flexible multicast and/or broadcast reliability (e.g., full ACK or flexible ACK, such as partial ACK, location-based ACK, or context-aware ACK). Expiration time may be an expiration time of the message. Multicast and/or broadcast scope may be a physical distance or a number of hops to multicast and/or broadcast the MAC frame. Maximum retries may be a maximum number of retransmissions of a MAC frame to the next hop. ACK order may describe the order (e.g., sequence) for neighbors to send back ACK. ACK transmission behavior may specify how ACK may be sent back from a receiving member/peer. A forward flag may be used to indicate if the current MAC data frame may be forwarded again to the next hop after it may be received. With such information included in the MAC data frame, other peers within the proximity may postpone their channel access attempt if the current MAC data frame may be forwarded again, e.g., so that potential future collision may be reduced and/or abated.

A MAC multicast and/or broadcast ACK frame may be provided. FIG. 13 depicts an example format for a MAC multicast and/or broadcast ACK frame. It may be transmitted in a unicast manner from a peer, such as a receiver or helper, to another peer, such as a distributor or helper. A MAC multicast and/or broadcast ACK frame may include one or more of the following fields/parameters: hash, help willingness, list of buffer data, traffic load, and list of neighbors. The fields or parameters may be leveraged for collaborative multicast and/or broadcast mission or retransmission. A hash may be a hashed value that may include one or more of the following: a group ID, an application ID, and a VL ID. Help willingness may indicate if a sender of the ACK may or may not be willing to act as a helper. A list of buffer data may be a list of sequence numbers of buffer data at a sender of the ACK frame. A traffic load may be the traffic load of a sender of the ACK. A list of neighbors may include neighbor information of a sender of the ACK such as, link quality to a neighbor, a traffic load at a neighbor, or the like. Other information (e.g., location and mobility of the issuer of the ACK) may be included in the MAC multicast and/or broadcast ACK frame.

A MAC multicast and/or broadcast aggregated ACK frame may be provided. FIG. 14 depicts an example format for an aggregated MAC multicast and/or broadcast ACK. As shown in FIG. 14, a MAC multicast and/or broadcast aggregated ACK frame may include one or more of the following: a hash, a multicast source address, a success/failure flag, or a list of successful/failed receivers. The hash may be a hashed value that may include one or more of the following: a group ID, an application ID, or a VL ID. A multicast source address may be an address of a multicast source or sender. A success/failure flag may indicate if a receiver (e.g., a receiver included in the next field) may be a successful receiver or a failed receiver. A list of successful/failed receivers may be a list of one or more receivers that successfully received a previous data frame, and/or failed to receive the previous data frame.

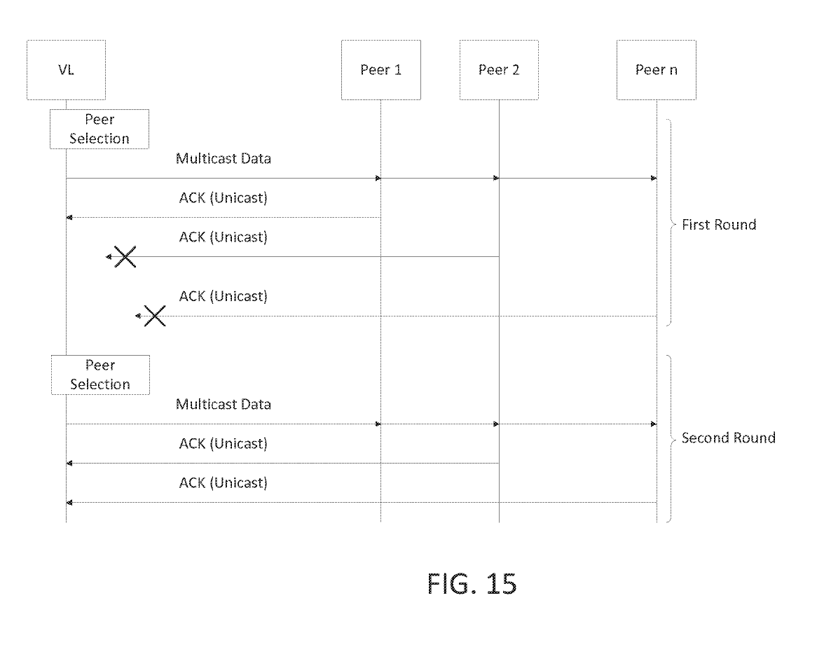

Centralized one-hop multicast and/or broadcast may be provided. Centralized one-hop multicast and/or broadcast may be a VL-to-peers multicast and/or broadcast as depicted in FIG. 1. FIG. 15 depicts a messaging chart of an example centralized one-hop multicast and/or broadcast. The VL may request to get ACK from involved peers, e.g., based on reliability type and/or the application's requirements. The VL may indicate an ACK type field in a multicast and/or broadcast MAC data frame, so that peers may perform appropriate ACK operations. The VL may continue transmitting data to peers or may initiate a new transmission, e.g., based on the ACKs from peers and application/service requirements. The VL may perform peer selection at the beginning of each multicast and/or broadcast round, where a round may be a multicast and/or broadcast transmission, which may be a retransmission or a transmission. An ACK may be broadcast from one or more peers (e.g., peer 1, peer 2, or peer n) to the VL, e.g., in accordance with the ACK type.

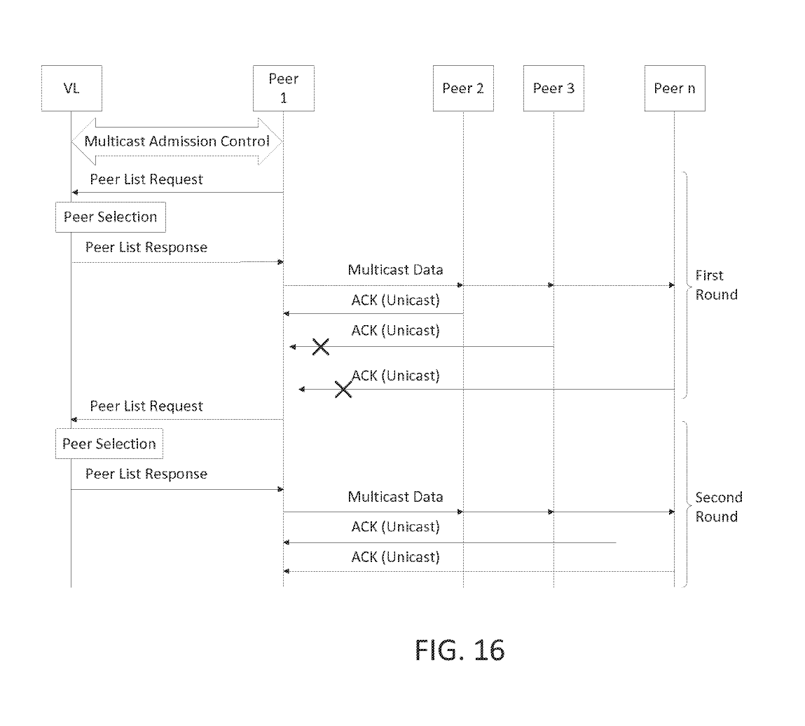

Hybrid one-hop multicast and/or broadcast may be provided. For a hybrid one-hop multicast scenario, such as the hybrid one-hop multicast scenarios shown in FIG. 2, a control may be centralized and the peer-to-peers multicast and/or broadcast may be distributed. For example, the peers-to-peers multicast and/or broadcast may occur without going through the VL. An exemplary multicast procedure may be depicted in FIG. 16.

FIG. 16 depicts a message chart of an example hybrid one-hop multicast and/or broadcast. Peer 1 and the VL may conduct a multicast admission control process. Peer 1 may check with the VL to get a list of peers that may receive the multicast data (e.g., at the beginning of a multicast round). For example, Peer 1 may issue multicast and/or broadcast to potential peers that may be around a physical area. In this case, Peer 1 may check with the VL to get a list of peers that may be around the physical area. ACK may be broadcast from one or more peers (e.g., peer 2, peer 3, or peer n) to peer 1, e.g., in accordance with an indicated ACK type.

In retransmission (e.g., context-aware collaborative retransmission), a peer may be chosen as a helper to perform the retransmission on behalf of a source peer, such as Peer 1, based on peer context information. The helper may be determined by the VL or the source peer. The VL, the helper, or the source peer may perform ACK aggregation. ACK may be broadcast from one or more peers (e.g., peer 2, peer 3, or peer n) to peer 1.

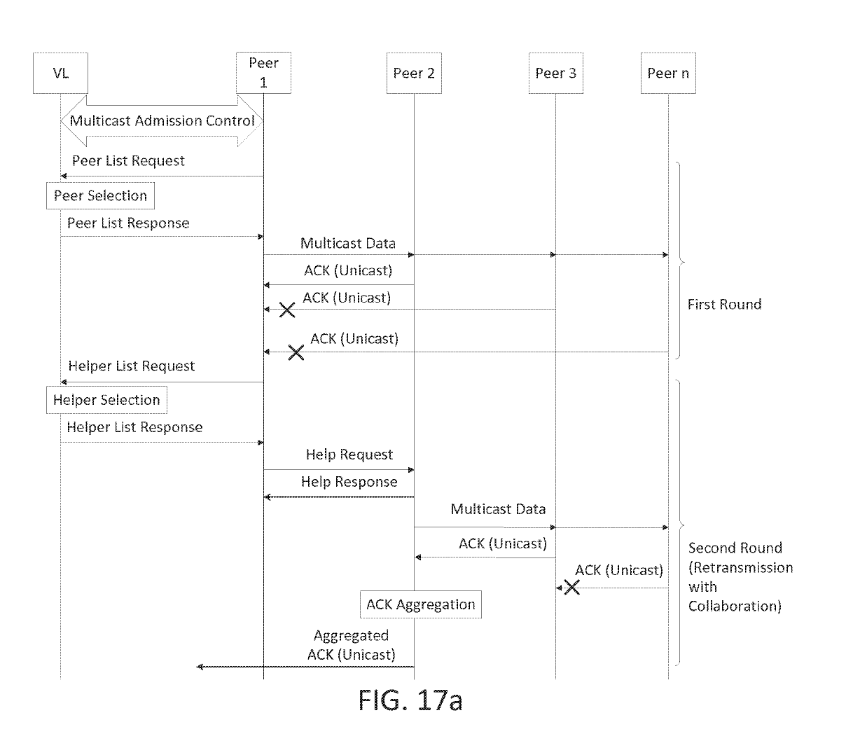

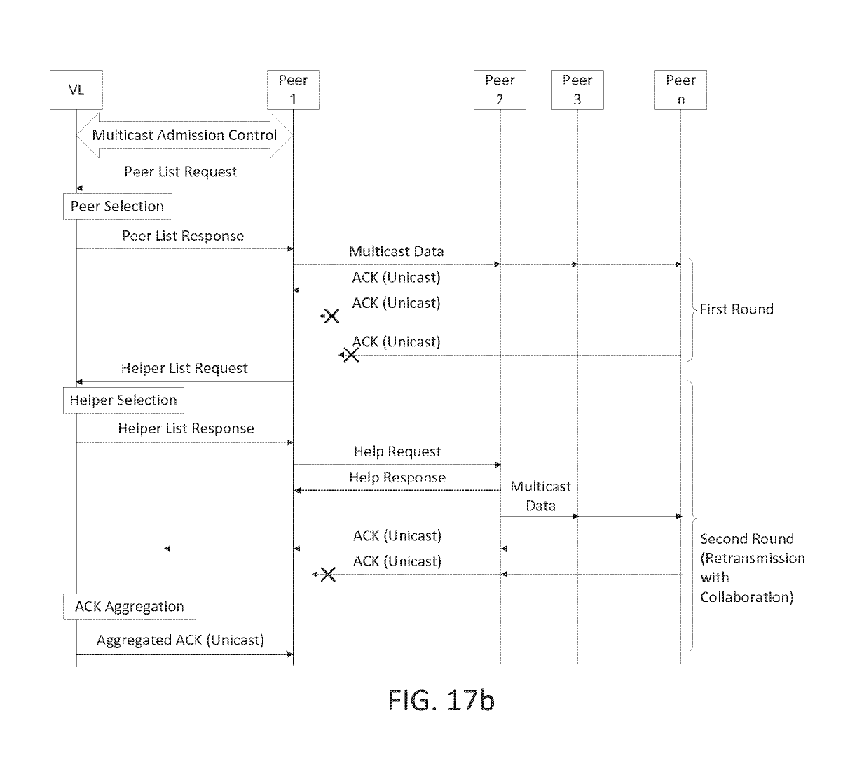

FIG. 17A and FIG. 17B depict exemplary message charts of an example hybrid one-hop multicast and/or broadcast that may have collaboration.

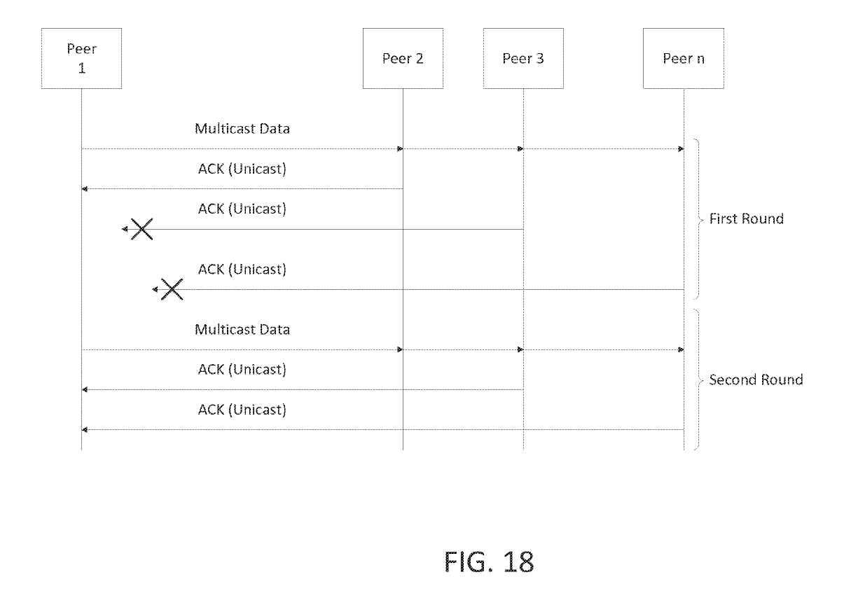

Distributed one-hop multicast and/or broadcast may be provided. A distributed one-hop multicast scenario may be the distributed one-hop multicast example shown in FIG. 3. FIG. 18 depicts a message chart of an example distributed one-hop multicast and/or broadcast procedure. In FIG. 18, a source peer, such as Peer 1, may multicast data to other peers. The source peer may control other peers.

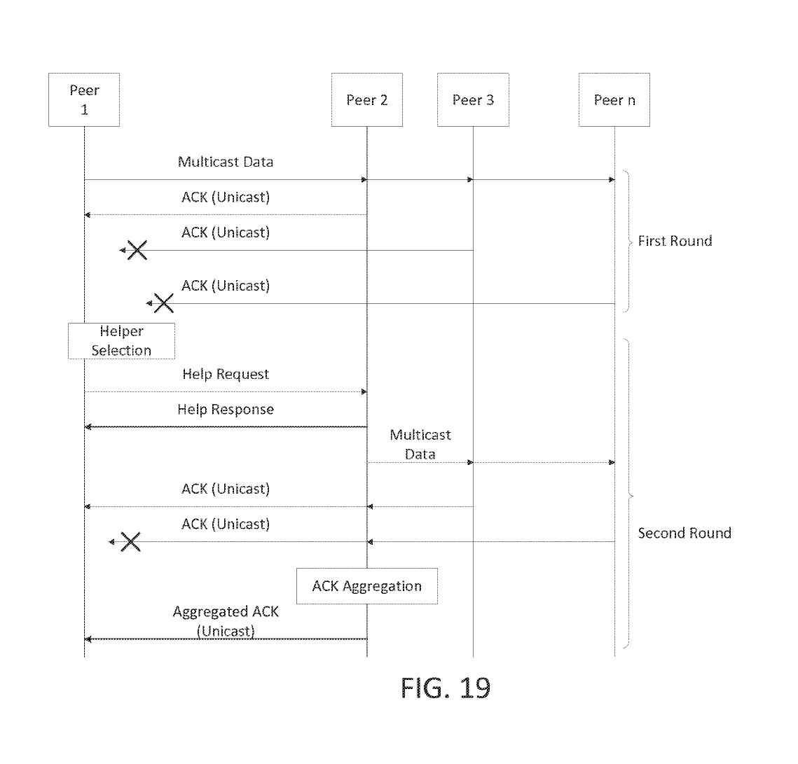

FIG. 19 depicts a message chart of an example distributed one-hop multicast and/or broadcast that may have collaboration (e.g., to improve retransmission). Peer 1 may multicast and/or broadcast a help request message to other peers. Peer 1 may receive multiple unicasted help responses from multiple potential helpers. Peer 1 may pick one or more helpers to help multicast the data. The picked peer or peers as helper or helpers may multicast the data to other peers on behalf of Peer 1. ACK may be broadcast from one or more peers (e.g., peer 2, peer 3, or peer n) to peer 1.

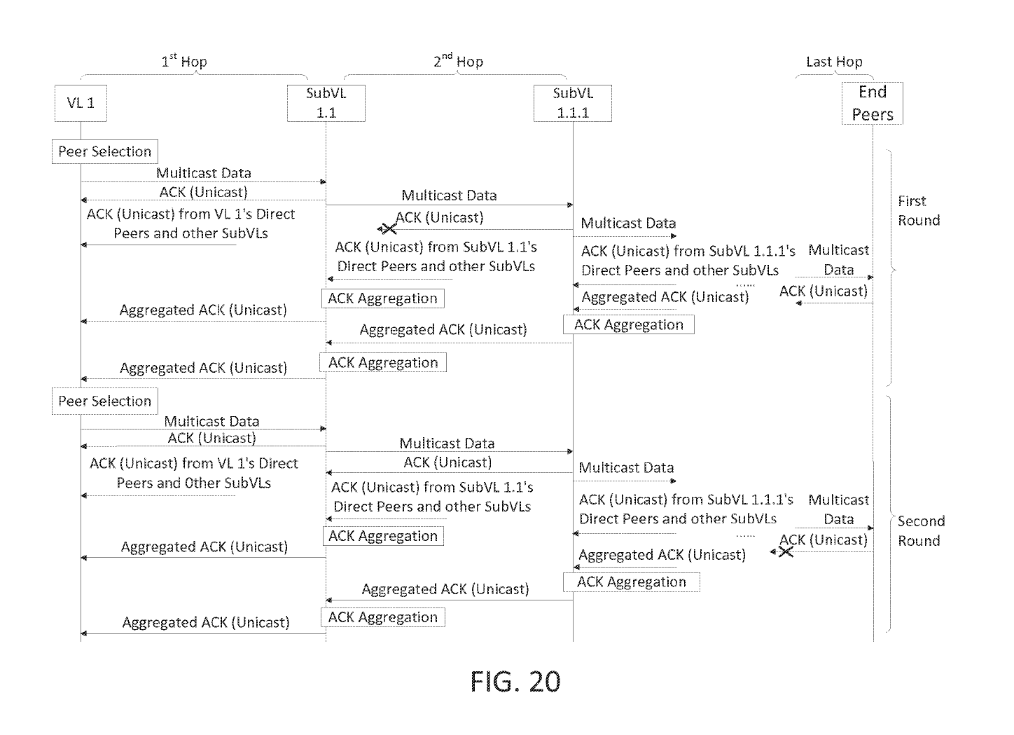

Centralized multi-hop multicast and/or broadcast may be provided. FIG. 20 depicts a message chart of an example centralized multi-hop multicast and/or broadcast. The centralized multi-hop multicast and/or broadcast may be used, for example, in a centralized VL-to-peers multi-hop multicast and/or broadcast such as the centralized VL-to-peers multi-hop multicast and/or broadcast show in FIG. 4A.

The SubVL at a hop may be responsible for relaying (e.g., multicasting/broadcasting) received data to one or more next-hop SubVLs. The SubVL(s) may relay the received data to its direct peers. The SubVL may receive ACKs (e.g., in unicast) from those one or more next-hop SubVLs and/or direct peers. The ACK from the one or more next-hop SubVLs may be aggregated ACK. Those aggregated ACKs may be aggregated at the SubVL.

The SubVL at a hop may send/forward ACK(s) without aggregation to its previous-hop SubVL. The SubVL at a hop may perform ACK aggregation and may send the aggregated ACK to the previous-hop SubVL or VL (e.g., an upstream SubVL or VL). A SubVL may receive aggregated ACK from its next-hop SubVL (e.g., a downstream SubVL).

ACK aggregation at a SubVL may be triggered, e.g., based on one or more conditions. For example, ACK aggregation at a SubVL may be triggered by one or more of the following: when receiving an aggregated ACK from a next-hop SubVL, when receiving a certain number of ACKs from direct peers, or periodically when a timer expires. The end peers may send normal unicast ACK to its direct SubVL. The SubVL at a hop may perform retransmission for its downstream peers and may also perform collaborative retransmission (e.g., to find helpers). ACK may be transmitted back in broadcast manner in a hop.

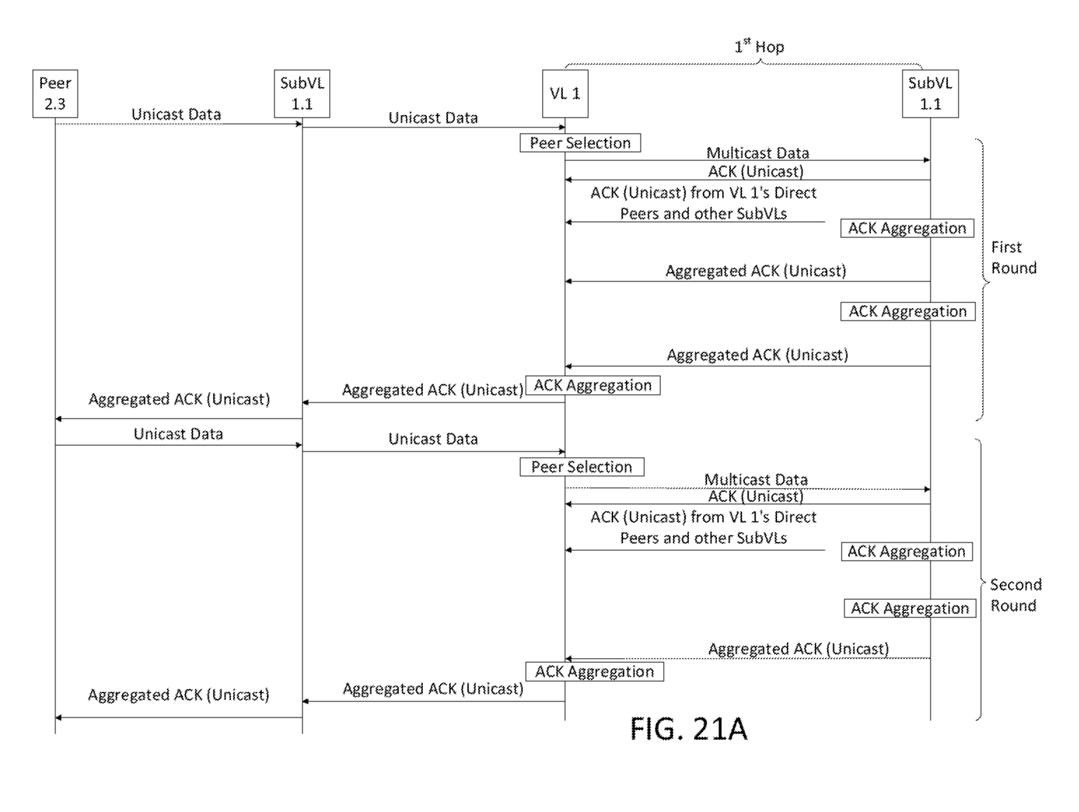

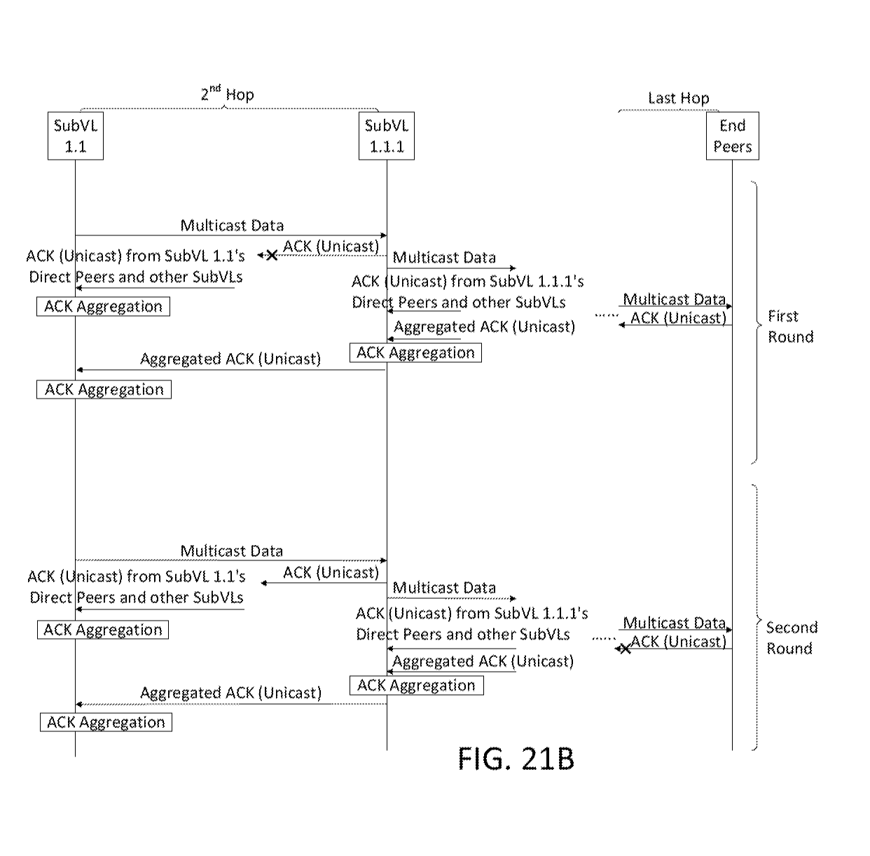

FIG. 21 depicts a message chart of an example centralized multi-hop multicast and/or broadcast procedure, which may be used for centralized peer-to-peers multi-hop multicast and/or broadcast, such as that shown in FIG. 4B. The example of FIG. 21 may include multiple phases (e.g., two phases). A source peer, such as peer 2.3 shown with respect to FIG. 4B, may unicast the data upstream to a SubVL (e.g., SubVL 1.1), which may unicast the data to a VL (e.g., VL 1). The VL may multicast and/or broadcast the data down to other peers (e.g., directly or via SubVLs). The SubVL at a hop may perform retransmission to its downstream peers and may perform collaborative retransmission (e.g., to find helpers). ACK may be transmitted back in broadcast manner in a hop. The VL may unicast the aggregated ACK to the source peer, such as peer 2.3 shown with respect to FIG. 4B, via its direct SubVL, such as SubVL 1.1 shown with respect to FIG. 4B, e.g., after the VL performs ACK aggregation.

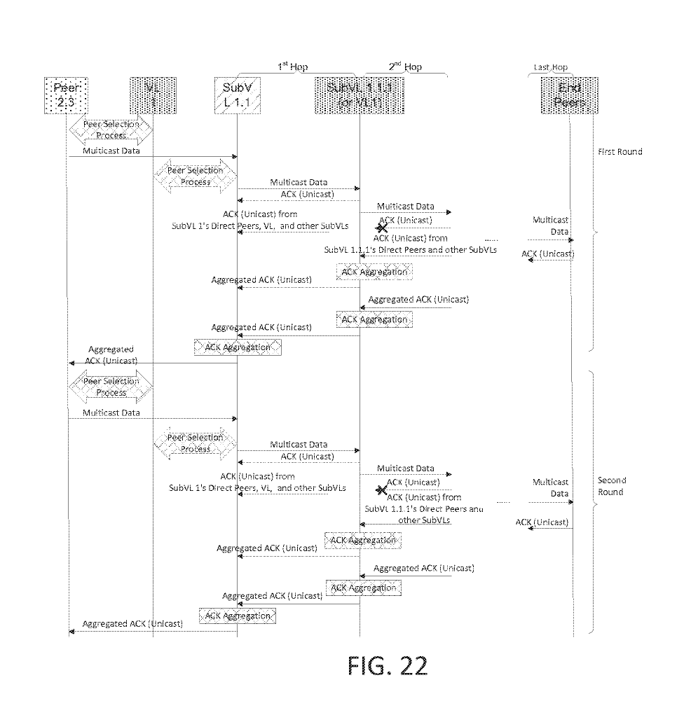

Hybrid multi-hop multicast and/or broadcast may be provided. FIG. 22 depicts a message chart of a hybrid multi-hop multicast and/or broadcast. Hybrid multi-hop multicast and/or broadcast may be performed using the hybrid multi-hop multicast and/or broadcast architecture shown with respect to FIG. 5.

Referring again to FIG. 22, a source peer or peers, such as peer 2.3 shown with respect to FIG. 5, or the direct SubVL of the source peer or peers, such as SubVL 1.1 shown with respect to FIG. 5, may perform a peer selection process. The peer selection process may include a peer list request message that may be sent from a peer or a SubVL to the VL, a peer selection that may be performed at the VL, and a peer list response message that may be sent from the VL to a peer or a SubVL. A source peer may multicast or unicast the data to its next hop (e.g., its direct SubVL). The direct SubVL of the source VL may forward (e.g., multicasts/broadcasts) the data to the next hop. Other SubVLs may continue to multicast and/or broadcast the data until it reaches one or more end peers.

Other SubVLs and the VL (e.g., if the VL may have direct end peers) may perform ACK aggregation. The direct SubVL of the source peer may be responsible for directly unicasting an aggregated ACK to the source. A helper-assisted collaborative retransmission mechanism may be applied in one or more hops (e.g., applied separately or in a joint manner). The SubVL at a hop may perform retransmission for its downstream peers and may perform collaborative retransmission (e.g., to find helpers). ACK may be transmitted back in a broadcast manner in a hop.

Flexible configuration of MAC multicast features may be provided. MAC features disclosed herein may be flexibly configured based on different types of devices or logical functions in a P2P communications system, which may include one or more of the following: SuperVL, VL, SubVL, or peer. Peers with more capabilities may support more multicast features. A SuperVL, a VL, or a SubVL may have more multicast features than a regular peer, which may have a smaller set of multicast features. A source peer may determine its requested multicast features and disable non-requested multicast features when it multicasts MAC frames. A source peer may disable a flexible multicast reliability feature or may leverage a set of ACK type or types disclosed herein that may support flexible multicast reliability. The source peer may disable or enable (e.g., adaptively disable or enable) ACK collision avoidance mechanisms, such as ACK broadcast, ACK alignment, and/or ACK aggregation as described herein. Intermediate peers and/or destination peers may decide (e.g., adaptively decide) to join a collaborative multicast transmission feature. Multicast admission control as described herein may or may not be included for some multicast and/or group communication applications.

Mechanisms for indicating/negotiating MAC multicast features may be provided. The supported multicast features at each peer may be indicated, exchanged, and/or negotiated during peer association between two peers (e.g., peer 1 makes association with peer 2). For example, when peer 1 performs association with peer 2, peer 1 may indicate its supported multicast features to peer 2 in an association request message. Peer 2 may indicate its supported multicast features to peer 1 in an association response message. Peer 1 and peer 2 may negotiate multicast features to be supported (e.g., by both peers). For example, peer 2 may instruct peer 1 to support one or more multicast features.

The supported multicast features at a source peer may be indicated, exchanged, and/or negotiated during multicast admission control. The source peer 1 may indicate its supported multicast features to the VL in a multicast and/or broadcast request message (e.g., when the source peer 1 performs multicast admission control with the VL). The source peer 1 may request multicast features to be supported at the VL and other peers (e.g., in the multicast and/or broadcast request message). The VL may indicate its supported multicast features in a multicast and/or broadcast response message to the source peer 1. The VL may indicate the approved multicast features to be supported at the source peer in a multicast and/or broadcast response message.

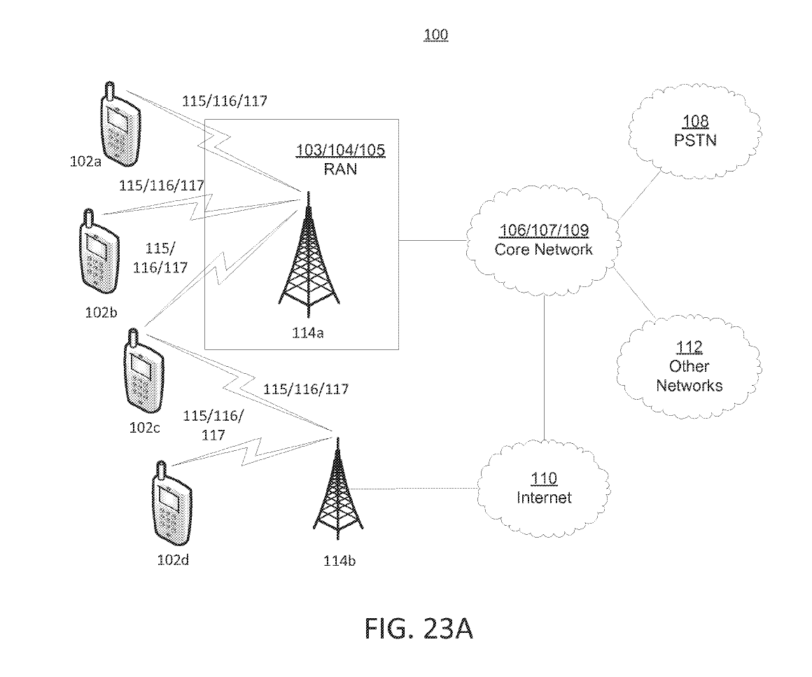

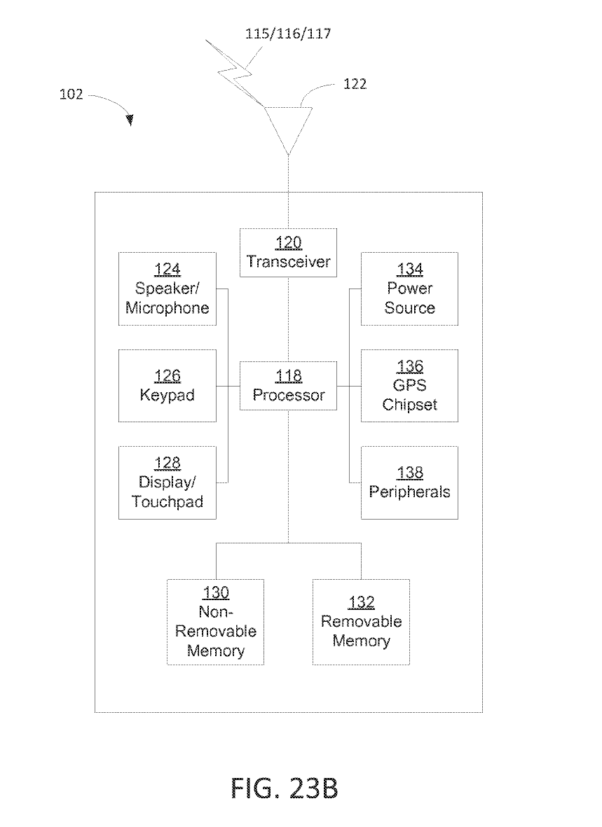

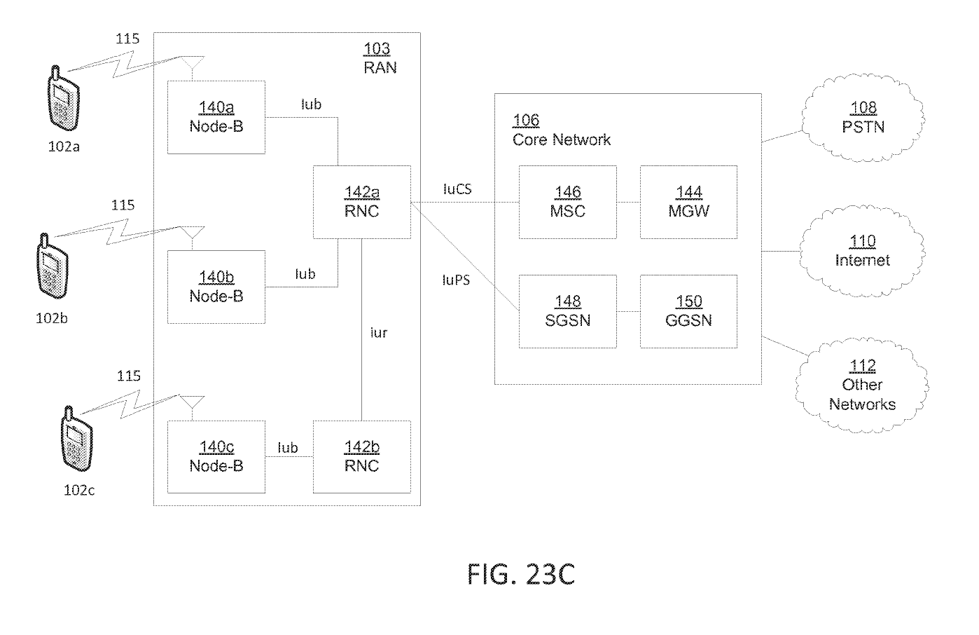

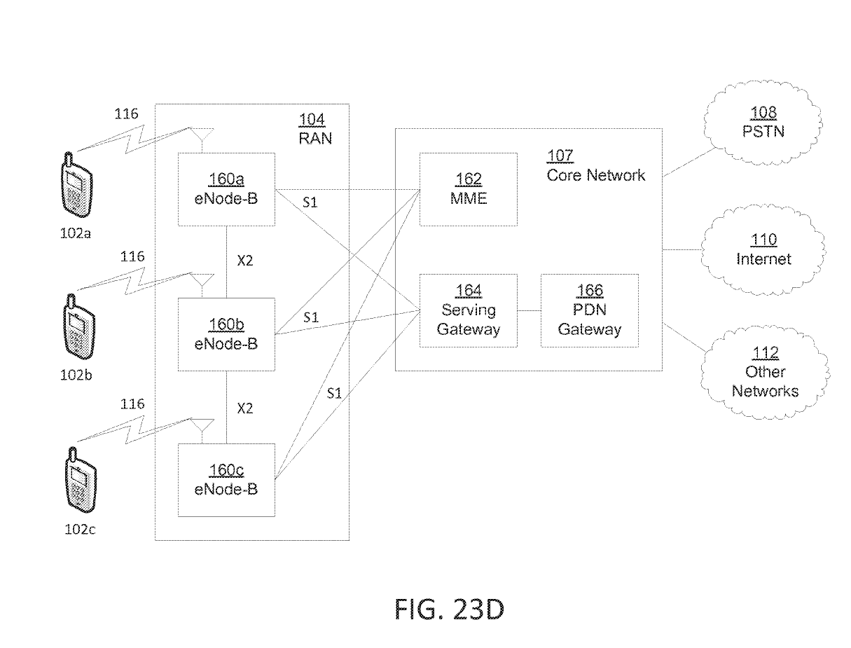

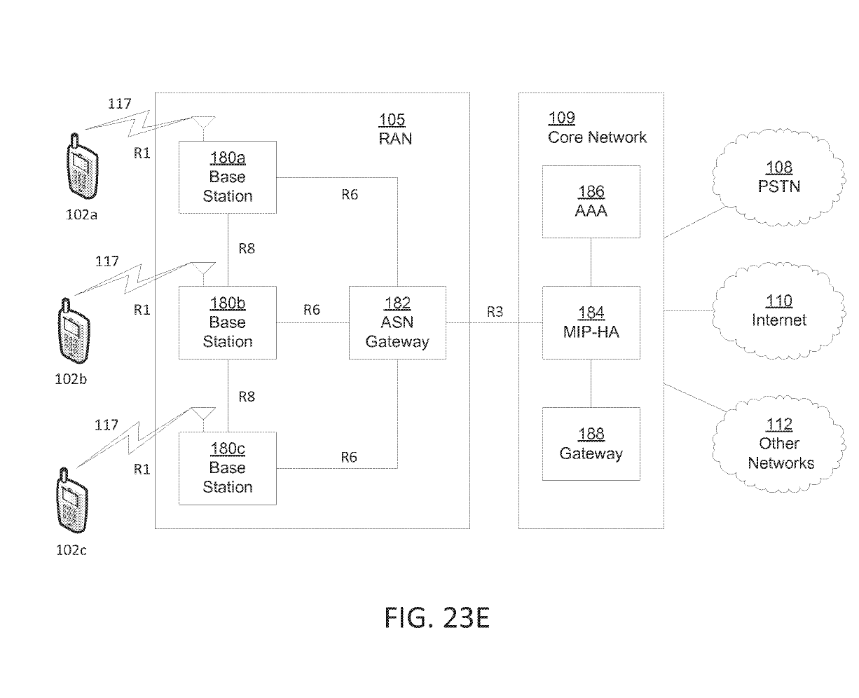

FIG. 23A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 23A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a. 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a. 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b. 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 23A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 23A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 23A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 23A may be configured to communicate with the base station 114a, which may employ a cellular-based radio technology, and with the base station 114b, which may employ an IEEE 802 radio technology.

FIG. 23B is a system diagram of an example WTRU 102. As shown in FIG. 23B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 23B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs). Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 23B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 23B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 23C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 23C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 23C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 23C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a. 102b, 102c with access to packet-switched networks, such as the Internet 110, to facilitate communications between and the WTRUs 102a. 102b, 102c and IP-enabled devices.

As noted above, the core network 106 may also be connected to the networks 112, which may include other wired or wireless networks that are owned and/or operated by other service providers.

FIG. 23D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a. 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b. 160c may be associated with a particular cell (not shown) and may be configured to handle radio resource management decisions, handover decisions, scheduling of users in the uplink and/or downlink, and the like. As shown in FIG. 23D, the eNode-Bs 160a, 160b, 160c may communicate with one another over an X2 interface.

The core network 107 shown in FIG. 23D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a. 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the SI interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a. 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b. 102c with access to the networks 112, which may include other wired or wireless networks that are owned and/or operated by other service providers.

FIG. 23E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 23E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a. 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b. 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 23E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a. 102b, 102c with access to the networks 112, which may include other wired or wireless networks that are owned and/or operated by other service providers.

Although not shown in FIG. 23E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1.-34. (canceled)

35. A method for peer to peer communication, the method comprising:
receiving, by a wireless transmit/receive unit (WTRU), a medium access control (MAC) data frame that indicates a flexible acknowledgement (ACK) type;
determining whether to send an ACK message based on the flexible ACK type; and
sending the ACK message on a condition that it is determined to send the ACK message.

36. The method of claim 35, wherein the flexible ACK type indicates that the ACK message is to be sent from a subset of peers.

37. The method of claim 36, further comprising determining that the WTRU is in the subset of peers.

38. The method of claim 36, wherein the subset of peers consists of a single peer.

39. The method of claim 35, wherein the flexible ACK type indicates that the ACK message is to be sent from a peer within a proximity to a location.

40. The method of claim 39, further comprising determining that the WTRU is within the proximity to the location.

41. The method of claim 35, wherein the flexible ACK type indicates that the ACK message is to be sent from a peer associated with a context.

42. The method of claim 41, wherein the context is associated with at least one of link quality, residual energy, application or service profile, application or service category, user profile, device profile, or a mobility state.

43. The method of claim 41, further comprising determining that the WTRU is associated with the context.

43. The method of claim 35, wherein the flexible ACK type indicates that the ACK message is to be sent from a peer based on at least one of a packet type, a packet priority, or a packet quality of information.

45. The method of claim 35, wherein the MAC data frame is a multicast MAC data frame.

46. A wireless transmit/receive unit (WTRU) comprising:
a processor configured at least in part to:
receive a medium access control (MAC) data frame that indicates a flexible acknowledgement (ACK) type;
determine whether to send an ACK message based on the flexible ACK type; and
send the ACK message on a condition that it is determined to send the ACK message.

47. The WTRU of claim 46, wherein the flexible ACK type indicates that the ACK message is to be sent from a subset of peers.

48. The WTRU of claim 47, wherein the processor is further configured to determine that the WTRU is in the subset of peers.

49. The WTRU of claim 47, wherein the subset of peers consists of a single peer.

50. The WTRU of claim 46, wherein the flexible ACK type indicates that the ACK message is to be sent from a peer within a proximity to a location.

51. The WTRU of claim 50, wherein the processor is further configured to determine that the WTRU is within the proximity to the location.

52. The WTRU of claim 46, wherein the flexible ACK type indicates that the ACK message is to be sent from a peer associated with a context.

53. The WTRU of claim 52, wherein the context is associated with at least one of link quality, residual energy, application or service profile, application or service category, user profile, device profile, or a mobility state.

54. The WTRU of claim 52, wherein the processor is further configured to determine that the WTRU is associated with the context.

55. The WTRU of claim 46, wherein the flexible ACK type indicates that the ACK message is to be sent from a peer based on at least one of a packet type, a packet priority, or a packet quality of information.

56. The WTRU of claim 55, wherein the MAC data frame is a multicast MAC data frame.
